(19) United States
(12) Patent Application Publication
(10) Pub. No.: US 2025/0385430 A1
(43) Pub. Date: Dec. 18, 2025

(54) Multi-band resonance antenna and device including the multi-band resonance antenna

(71) Applicant: Intel Corporation, Santa Clara, CA (US)

(72) Inventors: Jayprakash THAKUR, Bangalore (IN); Prathibha PEDDIREDDY, Bangalore (IN); Jay Vishnu GUPTA, Bangalore (IN); Praveen KUMAR, Bangalore (IN)

(21) Appl. No.: 18/743,181

(22) Filed: Jun. 14, 2024

(51) Int. Cl. H01Q 9/04; H01Q 5/328; H01Q 13/10; H01Q 13/18

(52) U.S. Cl. CPC H01Q 9/0421; H01Q 5/328; H01Q 13/103; H01Q 13/106; H01Q 13/18

(57) ABSTRACT

A multi-band resonance antenna. A multi-band resonance slot antenna includes a slot formed in a conductive plate, an exciting trace configured to excite the slot, and a tuning stub within an area of the slot. The length of the slot is less than a half wavelength of a desired resonance frequency. The tuning stub is an electric trace in an elongated shape along the slot and connected to a ground plane of the slot antenna. Another multi-band resonance antenna includes an electric trace on a printed circuit board, a control line configured to transfer a control signal, and a tuner circuit configured to tap at one or more points of the electric trace to ground based on the control signal. The antenna may be included in a device having a continual metal rim.

### BACKGROUND

Slot (metal cutout) antennas are available in commercial full metal systems. For example, a slot is formed in the back cover of the lid in a laptop computer to form a slot antenna. Half wavelength slot antennas are used in a laptop system in the display bezel. FIG. 1 shows an example slot antenna at the display side of a laptop computer.

The conventional slot antenna design has some problems. The resonance frequency of the slot antenna depends on the slot length that is half wavelength. The slot length is fixed for the required frequency band, and it is difficult to tune or modify the design after fabrication. The long slot requirement (half wavelength) in metal chassis may defy the purpose of seamless industrial design. In cases where a dielectric substance is used to fill the slot, it causes drop in antenna radiation efficiency. In mobile systems, it is difficult to get the half wavelength space due to compactness of the mobile systems. The planar inverted-F antenna (PIFA) has multiple traces used to get the multi-band resonances. However, for slot antenna this type of solution is not available.

In case of mobile personal computer (PC), multi-band cellular, Fifth Generation (5G), or Wi-Fi antenna design requires a fully plastic antenna keep-out area, or a portion of side metal edges of the mobile PC is used as an antenna with slots. Conventional slot antenna design for 5G/Wi-Fi has multiple slots or large plastic cuts in the z-axis of laptop sidewalls. This reduces the mechanical strength of the chassis and leads to poor design of the PC.

FIG. 2 shows an example slot antenna design. A slot antenna 200 includes an about half wavelength (λ/2) long slot 210 that is cut in a ground plane 220 (or a metal chassis) and is excited in the center, as shown in FIG. 2. The polarization of a slot antenna 200 is linear. The fields of the slot antenna are almost the same as a dipole antenna, but the field's components are interchanged, i.e., a vertical slot has a horizontal electric field, and a vertical dipole has a vertical electrical field. The slot antenna impedance is 485 Ohm at the center while dipole impedance is 72 Ohm, but the bandwidth of a narrow rectangular slot is equal to that of the related dipole.

If a slot antenna is considered in a system, λ/2 (half wavelength) long cut is made in the metal chassis or ground plane. An exciting element (e.g., a printed circuit board (PCB) trace) is used to feed the slot to get desired lowest frequency resonance. For desired frequency band, the slot length is fixed. In many of the cases it is difficult to get λ/2 length spacing in the system because of the adjacent sub-components. Once the slot is made in the system, it is difficult to tune or modify the design after fabrication with the conventional approach.

### BRIEF DESCRIPTION OF THE FIGURES

Some examples of apparatuses and/or methods will be described in the following by way of example only, and with reference to the accompanying figures, in which

FIG. 1 shows an example slot antenna at the display side of a laptop computer;

FIG. 2 shows an example slot antenna design;

FIG. 3 shows a slot antenna in accordance with one example;

FIGS. 4 and 5 show simulated S-parameters and efficiency (dB) of a slot antenna for a wireless local area network (WLAN), respectively, in accordance with the example disclosed herein;

FIGS. 6A and 6B show the current distribution without and with the tuning stub, respectively;

FIG. 7 shows the S parameter (S11 in dB) variation with the variation of the tuning stub length;

FIGS. 8A-8C show three slot antenna configurations;

FIG. 9A shows comparison of the simulation results for the three slot antenna configurations;

FIG. 9B shows variations of the resonance with varying position of the tuning stub from the left edge of the slot;

FIG. 10 shows comparison of return loss with and without use of the discrete components;

FIG. 11 shows an antenna radiation pattern of a Wi-Fi antenna in accordance with example disclosed herein;

FIG. 12 shows an example slot antenna with an antenna flexible printed circuit (FPC);

FIG. 13 shows an example antenna placement on the bottom of a device;

FIG. 14A shows an example metal barricade to reduce radio frequency interference (RFI) from system with a metal partition;

FIG. 14B shows example provision for cable routing in the barricade;

FIG. 15A shows an example barricade;

FIG. 15B shows an integration of slot antennas with the barricade;

FIGS. 16A, 16B, and 16C show return loss, efficiency, and isolation between the antennas, respectively, with the barricade installed above the slot antenna;

FIG. 17A shows efficiency drop at 6.2 GHz;

FIG. 17B shows improved efficiency at 6.2 GHz band by increasing the internal height of the barricade;

FIG. 18 shows integration of slot antennas on the side wall of a device;

FIG. 19 shows an example slot antenna printed circuit board (PCB);

FIGS. 20A, 20B, and 20C show reflection coefficient (S11), isolation, and efficiency, respectively;

FIGS. 21A and 21B show conventional 5G/Wi-Fi antenna solutions with slots in the sidewall of chassis and full plastic sidewall, respectively;

FIG. 22 shows an example metallic chassis with a continual metal rim without any plastic slots in the rim;

FIG. 23 shows example placement of four 5G antennas in a continual metal rim chassis of a laptop;

FIG. 24 shows an extruded view of the 5G main antenna and the MIMO antenna placed in a corner of a continual metal rim chassis of a laptop;

FIG. 25 shows an example 5G main antenna;

FIG. 26A show the details of the 5G main antenna FPC;

FIG. 26B shows the 5G main antenna FPC from a different direction;

FIG. 27 shows the details of the tuner IC and tuner control lines;

FIGS. 28-30 show the test results of the 5G main antenna;

FIG. 31 shows an example 5G diversity antenna FPC;

FIG. 32 shows S11 parameters (dB) of the 5G diversity antenna for all two tuner states;

FIG. 33 shows efficiency (dB) of the 5G diversity antenna for all two tuner states;

FIG. 34 shows efficiency (dB) of the low band of the 5G diversity antenna for all two tuner states;

FIG. 35 shows an example MIMO antenna FPC in a system;

FIGS. 36 and 37 show the test results including S11, isolation (S12) and efficiency, respectively;

FIG. 38 illustrates a user device in which the examples disclosed herein may be implemented; and

FIG. 39 illustrates a base station or infrastructure equipment radio head in which the examples disclosed herein may be implemented.

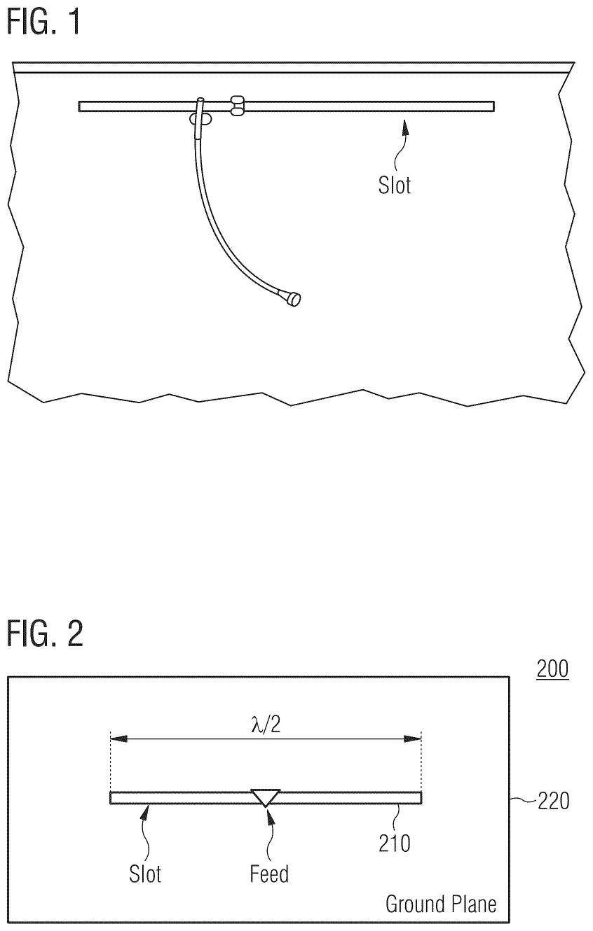

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

Example slot antennas are disclosed herein. A slot antenna is a type of antenna that includes a metal surface, typically a flat metal plate or a waveguide, with one or more slots cut out of it. The slots formed in a conductive plate act as radiating elements, allowing the antenna to emit and receive electromagnetic waves. The slot antenna may include a rectangular slot cut in a flat metal sheet. However, various shapes and configurations may be used, including circular, elliptical, and more complex designs. The dimensions and shape of the slot determine the operating frequency and bandwidth of the slot antenna. Slot antennas may be fed by a transmission line such as a coaxial cable or a microstrip line.

In one example, the antenna size can be reduced while achieving multiple resonant frequencies. In this example, the electrical length of the slot antenna is increased without increasing the physical dimension of the slot. This is achieved by adding a tuning stub along with an antenna excitor that creates multi band resonances. The electrical length of the slot is controlled using a tuning stub placed along with the excitor.

The multi-band resonance slot antenna includes a slot formed in a conductive plate, an exciting trace configured to excite the slot, and a tuning stub within an area of the slot. The length of the slot is less than a half wavelength of a desired resonance frequency. In examples, the exciting trace may be in a planar inverted-F antenna (PIFA) configuration. The tuning stub is an electric trace in an elongated shape along the slot and is connected to a ground plane of the slot antenna. The tuning stub may be connected to the ground plane via a capacitor or an inductor. The tuning stub may be configured to generate resonance of the slot antenna in a range of 2.4-2.5 GHz and 5.15-7.125 GHz, for example one resonance in a range of 2.4-2.5 GHz and two resonances in a range of 5.15-7.125 GHz.

In another example, a multi-band resonance antenna is provided for a full metal chassis device including a continual metal rim to avoid cuts in the sidewall (rim) of the device (e.g., a laptop PC, a desktop PC, a mobile computing device, or the like). This example addresses the challenges of mechanical strength and industrial design of the 5G/Wi-Fi system. In this example, a continual metal rim antenna solution is provided where there are no cuts in the metal sidewall of the chassis. This helps to build a premium metal chassis system design with mechanically strong chassis without any painting on the device (e.g., towards keyboard side of the laptop PC).

The multi-band resonance antenna includes an electric trace on a printed circuit board, a control line configured to transfer a control signal, and a tuner circuit configured to tap at one or more points of the electric trace to ground based on the control signal. In one example, the electric trace is configured to generate resonance at 617-798 MHz when no point of the electric trace is tapped to ground, at 791-894 MHz when the electric trace is tapped to ground at a first point, and at 880-960 MHz when the electric trace is tapped to ground at a second point. In another example, the electric trace may be configured to generate resonance at 617-894 MHz when no point of the electric trace is tapped to ground, and at 880-960 MHz when the electric trace is tapped to ground at a first point.

In some examples, a device (e.g., a laptop PC, a desktop PC, a mobile computing device, etc.) may include a chassis including a continual metal rim, a top cover, and a bottom cover, and one or more multi-band resonance antennas disclosed above. The antennas may include a main antenna, a diversity antenna, third and fourth antennas, wherein the main antenna and the diversity antenna are the multi-band resonance antenna disclosed herein. The device may include a first speaker transducer and a second speaker transducer in the chassis, and the first speaker transducer may be placed between the main antenna and the third antenna, and the second speaker transducer may be placed between the diversity antenna and the fourth antenna. The third and fourth antennas may be multiple-input multiple-output (MIMO) antennas. The third antenna may be a Wi-Fi antenna. The top cover includes an opening, and a glass cover may cover the opening.

In another example, a device may include a chassis including a bottom metal plate, including a slot, and a printed circuit board (PCB) including an electric trace configured to excite the slot, and a metal barricade mounted over the slot and the PCB. The PCB is mounted on the bottom metal plate. The metal barricade includes metal side walls and a metal top to cover the slot and the PCB. The bottom metal plate may include multiple slots for multiple slot antennas, and the metal barricade may include one or more metal partitions for separating each of the multiple slots. In examples, the metal barricade has an internal height of at least 10 mm (alternatively 15 mm).

In another example, a device may include a chassis including a metal side wall, the metal side wall including an opening, and a slot antenna mounted on the metal side wall behind the opening. The slot antenna includes a main slot antenna and an auxiliary slot antenna mounted on the metal side wall behind the opening. The chassis includes an isolation circuit placed between the main slot antenna and the auxiliary slot antenna and configured to connect a top of the opening and a bottom of the opening.

The example slot antennas will be explained in detail hereafter.

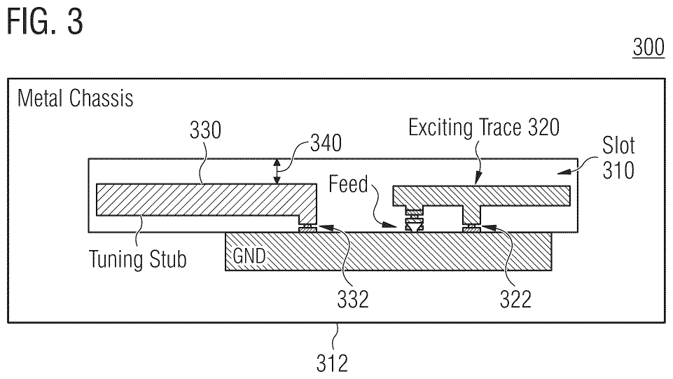

FIG. 3 shows a slot antenna 300 in accordance with one example. The slot antenna design in FIG. 3 may be used for a miniaturized slot antenna for a mobile device such as a laptop personal computer (PC), etc. The slot antenna 300 includes a slot 310 (e.g., a narrow rectangular slot) formed in a conductive plate 320 (e.g., a metal chassis or a ground plane), an exciting trace 320, and a tuning stub 330. The exciting trace 320 and the tuning stub 330 are placed behind the slot 310 within the area of the slot 310. The exciting trace 320 and the tuning stub 330 are electric traces (electrical transmission lines) printed on a PCB. The PCB may be a flexible PCB (FPC). The length of the slot 310 is less than the half wavelength (λ/2) of the desired lowest resonant frequency.

The exciting element 320 controls the resonating frequency and impedance matching of the slot antenna 300. The slot antenna 300 is fed at the feed point. The exciting element 320 may be in a PIFA configuration including a shorting trace 322. The shorting trace 322 is added to tune higher frequency resonance. It should be noted that the PIFA configuration shown in FIG. 3 is merely an example and the exciting element 320 may have a different configuration.

The tuning stub 330 has an elongated shape along the slot 310 as shown in FIG. 3. The tuning stub 330 is added to achieve the antenna's resonance characteristics for operation at the desired frequency. The tuning stub 330 is used to fine-tune the resonant frequency of the slot antenna. By adjusting the length and position of the tuning stub 330, the resonant frequency of the slot antenna can be shifted to align with the desired operating frequency. By adding the tuning stub 330 in the PCB trace, it is possible to achieve the resonance at a lower frequency even though the length of the slot 310 is less than the half wavelength (λ/2) of the desired lowest resonant frequency. The resonance frequency of the slot antenna 300 can be tuned according to the requirements by varying the length and position of the tuning stub 330. By adding the tuning stub 330, one more resonance can be obtained for a high frequency band compared to the slot antenna without the tuning stub, which helps to widen the high frequency bandwidth.

In some examples, the slot antenna 300 may include additional lumped element(s) to control (or shift) the resonance of the slot antenna 300. For example, the tuning stub 330 may be terminated with a component (e.g., a capacitor or an inductor) with the chassis ground.

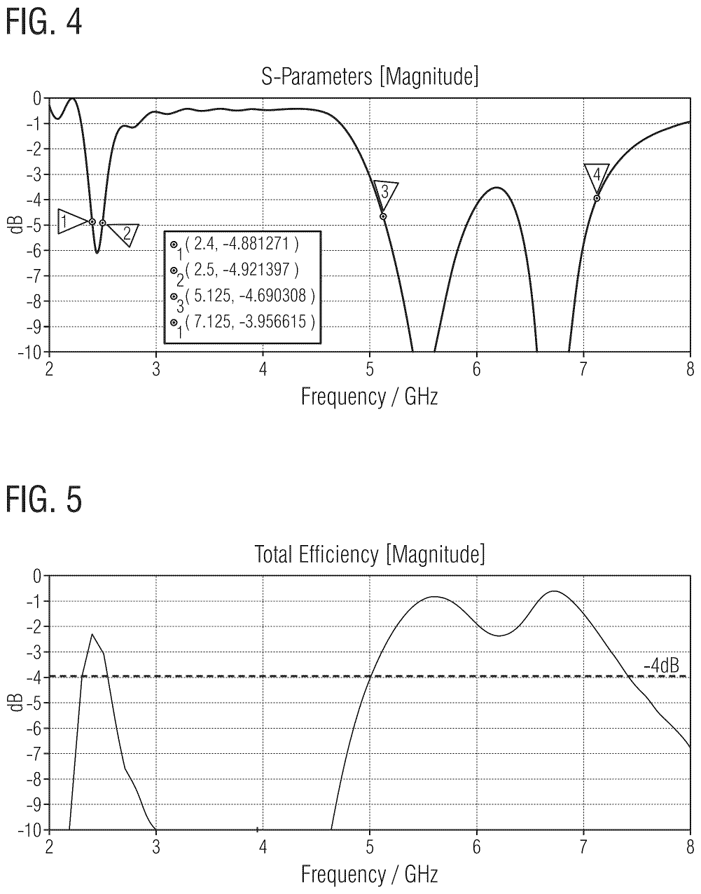

FIGS. 4 and 5 show simulated S-parameters and efficiency (dB) of a slot antenna for a wireless local area network (WLAN), respectively, in accordance with the example disclosed herein. In the simulation, the slot antenna is tuned for Wi-Fi-6E frequency bands (2.4-2.5 GHz and 5.15-7.125 GHz). The simulated S-parameter result in FIG. 4 shows that the slot antennas with the tuning stub 330 give a desired return loss for operating bands and have good impedance matching with 50 Ω. The simulated antenna efficiency in FIG. 5 shows that the Wi-Fi antenna total efficiency is better than −4 dB for 2.4 GHz band and 5-7 GHz band.

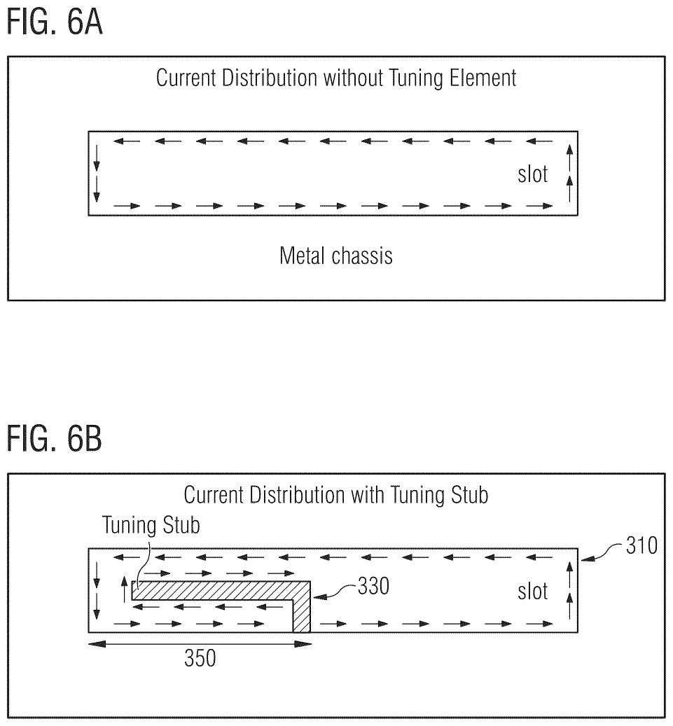

The virtual slot length of the slot 310 can be increased with the tuning stub 330. FIG. 6A shows the current distribution without the tuning stub and FIG. 6B shows the current distribution with the tuning stub 330. As shown in FIG. 6B, the tuning stub 330 increases the electrical path to control the resonance frequency. The resonance frequency of the slot antenna 300 can be tuned by varying the length of the tuning stub 330.

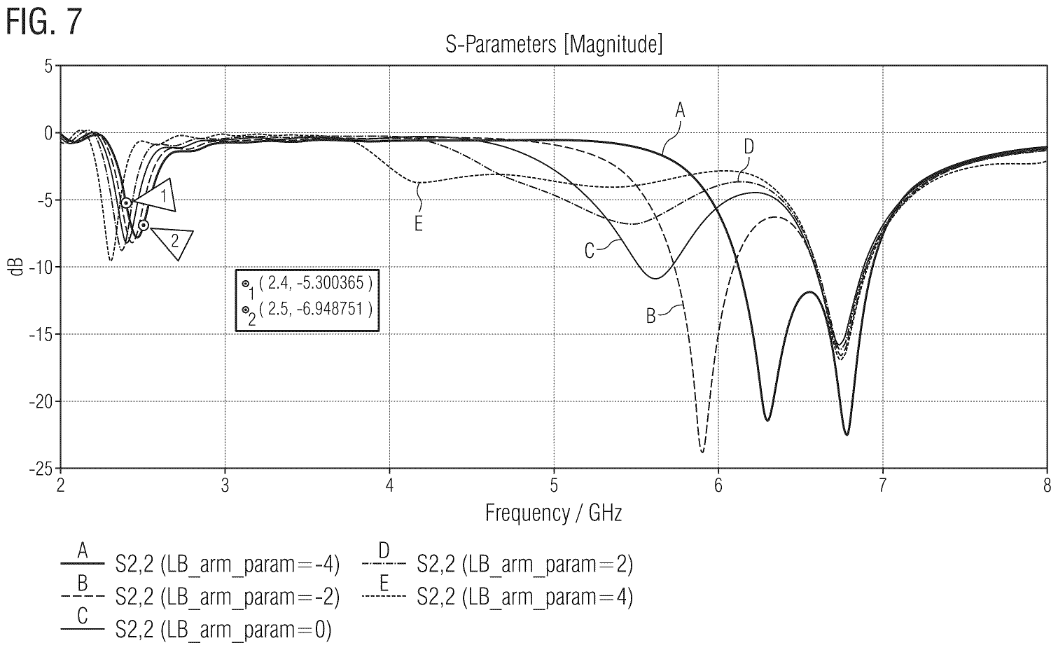

FIG. 7 shows the S parameter (S11 in dB) variation with the variation of the tuning stub length. In this example, the length of the tuning stub is varied from 9 mm to 17 mm in five steps. FIG. 7 shows the resonance shift towards lower frequency with the increase of the length of the tuning stub 330 within the given slot. By properly selecting the length of the tuning stub 330, the resonance frequency of the slot antenna 300 can be tuned.

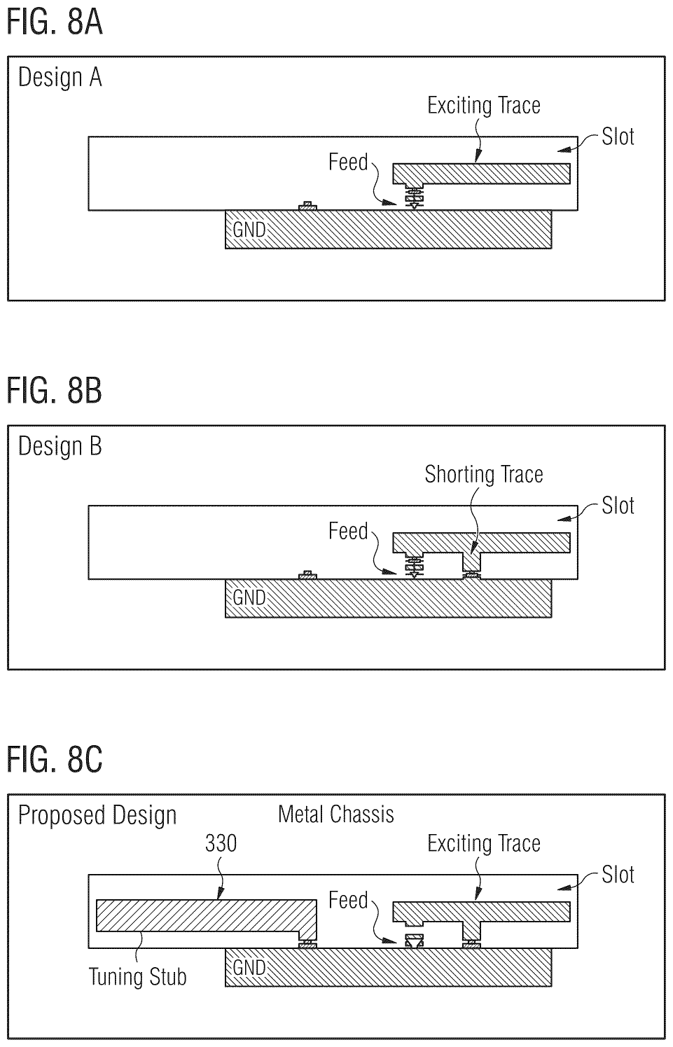

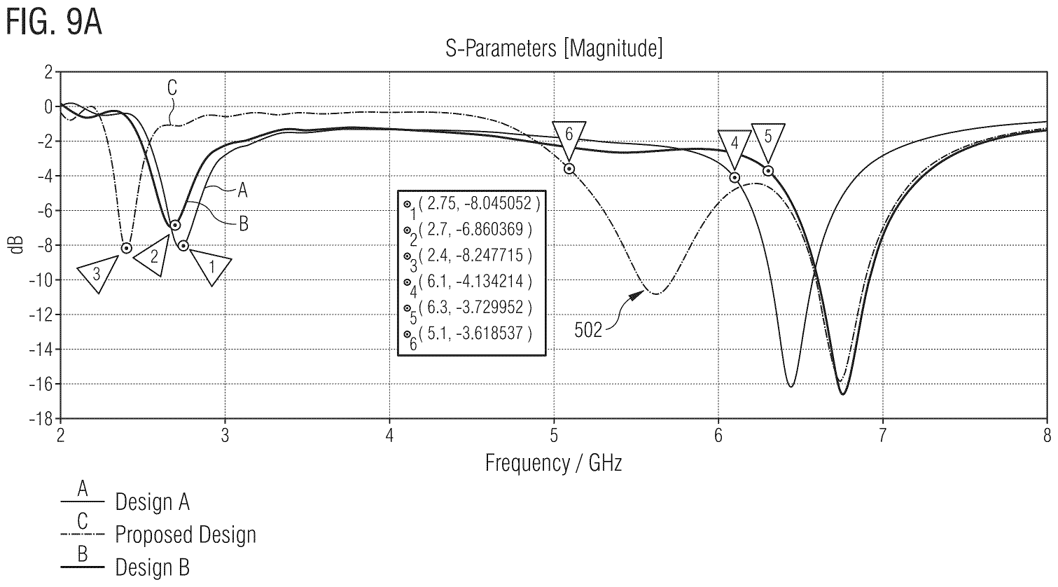

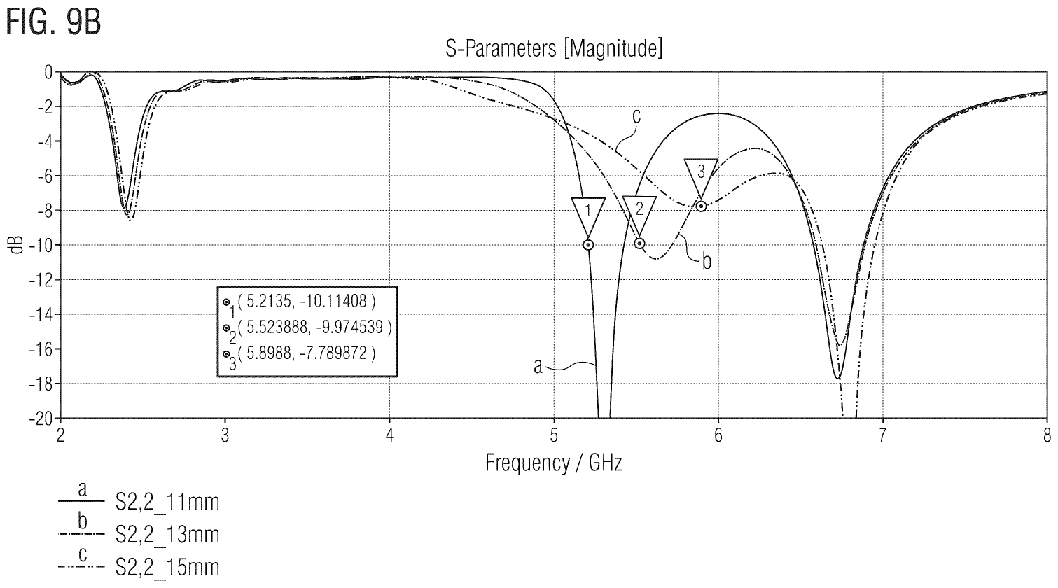

FIGS. 8A-8C show three slot antenna configurations and FIG. 9A shows comparison of the simulation results for the three slot antenna configurations. The first configuration (design A in FIG. 8A) is slot antenna only with an exciting element. The second configuration (design B in FIG. 8B) is a slot antenna with an exciting element with shorting (PIFA configuration). The third configuration (the proposed example in FIG. 8C) is a slot antenna with an exciting element with shorting (PIFA configuration) and a tuning stub 330. The first configuration (design A) is a conventional slot antenna with an exciting element to get dual band resonance. The shorting trace is added in the second configuration (design B) with an exciting element to tune higher frequency resonance. Alternatively, the shorting trace may be added in the first configuration (design A) as well. As shown in FIG. 9A, by adding the tuning stub 330, resonance frequencies in the range of around 2.4-2.5 GHZ, 5.125 GHz, and 7.125 GHz can be obtained, and one more resonance (around 5.125 GHz) can be obtained for high frequency band compared to the other two configurations (Design A and B in FIGS. 8A and 8B), as shown in FIG. 9A, which helps to widen the high frequency bandwidth. The advantage of adding the tuning stub is that the frequency bands can be tuned according to the requirement by varying the length of the tuning stub.

The reflection co-efficient (S11) graph for the three configurations is shown in FIG. 9A. The high band bandwidth is increased and the frequency shift of 300 MHz from 2.7 GHz to 2.4 GHz is seen with the configuration of FIG. 8C without increasing the physical dimension of the slot antenna. One more resonance 502 can be obtained for high frequency band compared to the other two configurations. Coupling between the tuning stub 330 and the edge of the slot 310 is crucial to achieve the resonance between 5-6 GHz. In examples, the coupling gap 340 (between the top edge of the tuning stub 330 and the upper edge of the slot 310) of 0.2 mm to 0.3 mm may be used to achieve the 5-6 GHz band as shown in FIG. 9A. The slot length in the examples may be 35 mm, and the tuning stub 330 may be positioned at 15 mm, 13 mm, or 11 mm from the left edge of the slot 310 (i.e., the distance 350 (shown in FIG. 6B) may be 15 mm, 13 mm, or 11 mm).

Ideally for a Wi-Fi slot antenna to achieve the 2.45 GHz band, λ/2 slot length is required. The example scheme disclosed herein helps to miniaturize the slot length with the help of the tuning stub 330. Introducing the tuning stub 330 inside the slot 310 increases the electric path for 2.45 GHz band. The coupling between the tuning stub 330 and slot 310 helps to get the required bandwidth between 5 to 6 GHz. The position of the tuning stub 330 helps to tune the resonance of 5-6 GHz band. For example, the tuning stub 330 may be positioned at 15 mm, 13 mm, or 11 mm from the left edge of the slot 310 (i.e., the point that the tuning stub 330 is connected to the ground (the distance 350) may be 15 mm, 13 mm, or 11 mm from the left edge of the slot 310). FIG. 9B shows variations of the resonance with varying position of the tuning stub 330 (i.e., varying distances 350).

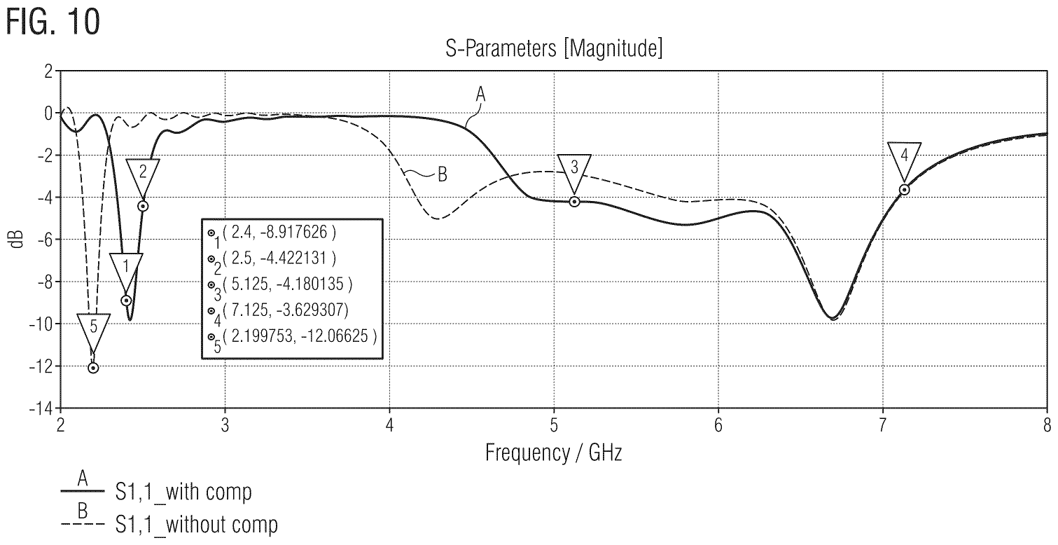

In some examples, a discrete component 332 (e.g., a capacitor or an inductor) may be added to the tuning stub 330. The tuning stub 330 may be connected to the ground via a discrete component 332. This can further improve the reflection co-efficient for the desired frequency band, improve bandwidth, and fine tuning after the antenna PCB (flexible printed circuit (FPC)) is fabricated. FIG. 10 shows comparison of return loss with and without use of the discrete components.

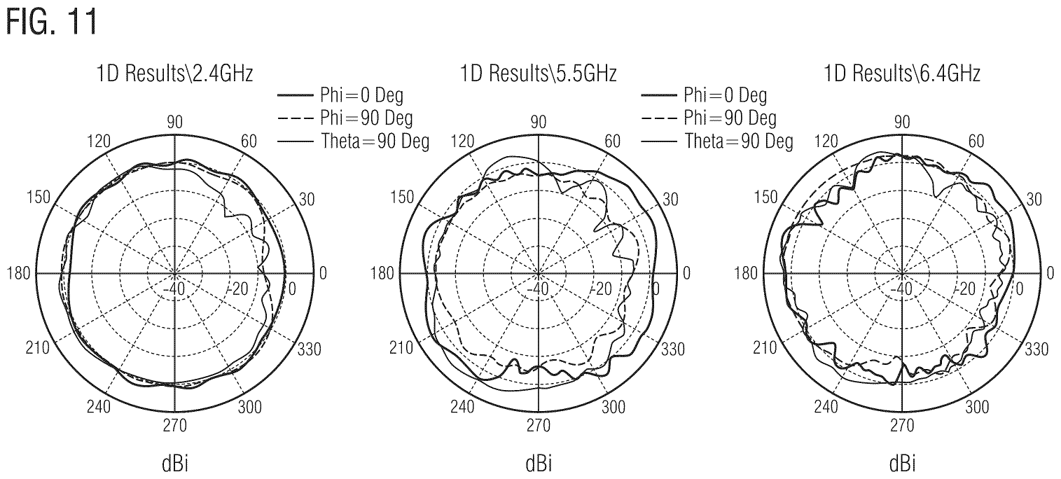

FIG. 11 shows an antenna radiation pattern of a Wi-Fi antenna in accordance with example disclosed herein at 2.4 GHz, 5.5 GHZ, and 6.4 GHz. The radiation pattern is observed on three different angles Phi=0°, Phi=90° and Theta=90°. The Phi=0° and phi=90° give a vertical cut of the system and theta 90° gives a horizontal cut of the system. Three cuts in the pattern provides useful information to an analyzer about its radiation angle coverage. The radiation pattern shows that the antenna has omni-directional pattern and does not have sharp null on any direction for all frequencies.

In another example, a slot antenna may be used with a barricade (e.g., for a desktop PC system, or the like). A slot antenna may be designed with a direct feed for a PC (e.g., a mini desktop PC) with a minimal plastic window for antenna radiation.

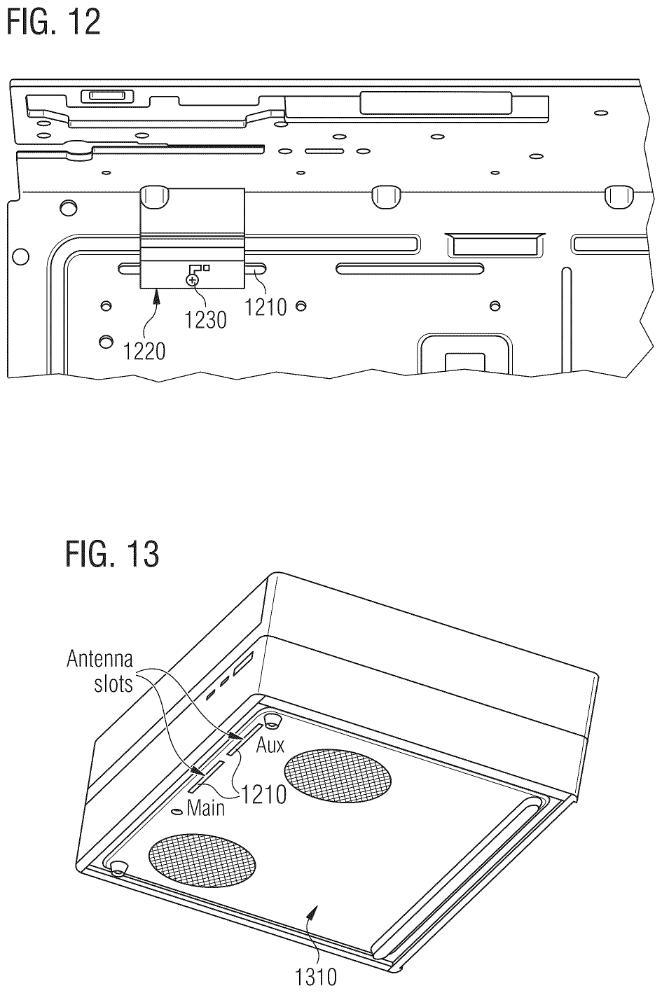

FIG. 12 shows an example slot antenna (half wavelength slot antenna) with an antenna FPC 1220. A slot(s) 1210 is formed in the metal chassis of the PC and an antenna FPC 1220 is placed behind the slot 1210. The antenna FPC 1220 may be installed using a screw 1230 and the slot 1210 may be excited by a direct feed FPC with a screw contact. For example, the slot 1210 may have a dimension of 3 mm width and 38 mm length. The antenna may work for Wi-Fi band of frequencies or other frequency bands.

FIG. 13 shows an example antenna placement on the bottom of a device. The device includes a metal bottom plate 1310, and the antenna may be placed on the bottom plate 1310 of the device without visible plastic window for antenna radiation. The device (e.g., a Wi-Fi system) may need two (or more) antennas including a main antenna and an auxiliary antenna. Both main and auxiliary antennas may be placed next to each other as shown in FIG. 13, and in that case, a partition wall may be placed therebetween to improve the isolation between the main and auxiliary antennas.

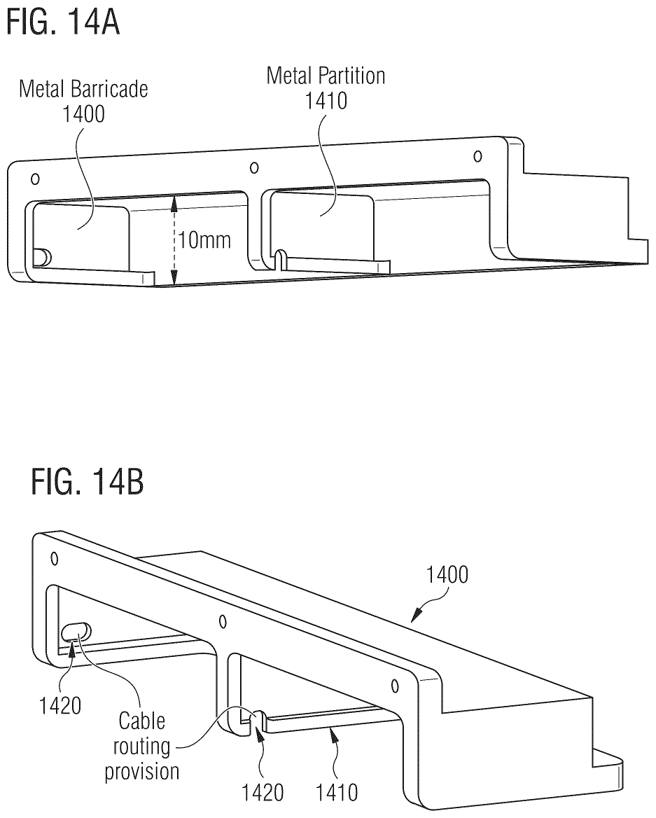

FIG. 14A shows an example metal barricade to reduce radio frequency interference (RFI) from system with a metal partition. Since the form factor of the device (e.g., a mini desktop PC, or the like) is small with a mother board being close to the antenna location, a barricade 1400 maybe put over the antenna(s) to restrict the RFI noise reaching the antenna(s). In examples, the slot antennas may be formed on the bottom plate 1310 of the device close to the edge of the bottom plate 1310 as shown in FIG. 13, and the barricade 1400 may cover the top and three sides as shown in FIG. 14A. In addition, if two or more antennas are located within the barricade 1400, a metal partition 1410 may be created inside the barricade 1400 to avoid coupling between the antennas (the main and auxiliary antennas) covered by the barricade 1400 and achieve good isolation between the antennas. In some examples, the barricade 1400 may have a height of at least 10 mm (or at least 15 mm).

FIG. 14B shows example provision for cable routing in the barricade 1400. Holes 1420 may be formed in the side wall of the barricade 1400 and the internal metal partition 1410 to take the antenna cables out of the barricade 1400. The holes 1420 may be formed in a corner of the wall of the barricade 1400 and the partition 1410 so that the cable does not block or interfere with the slots.

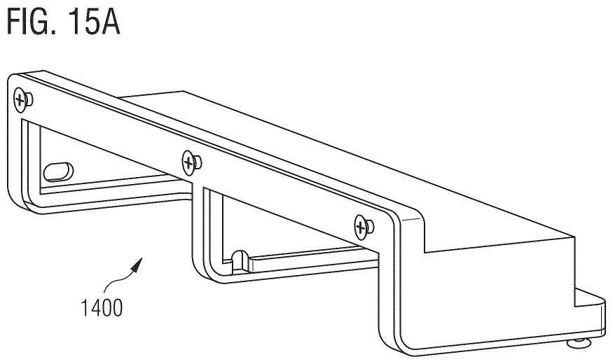

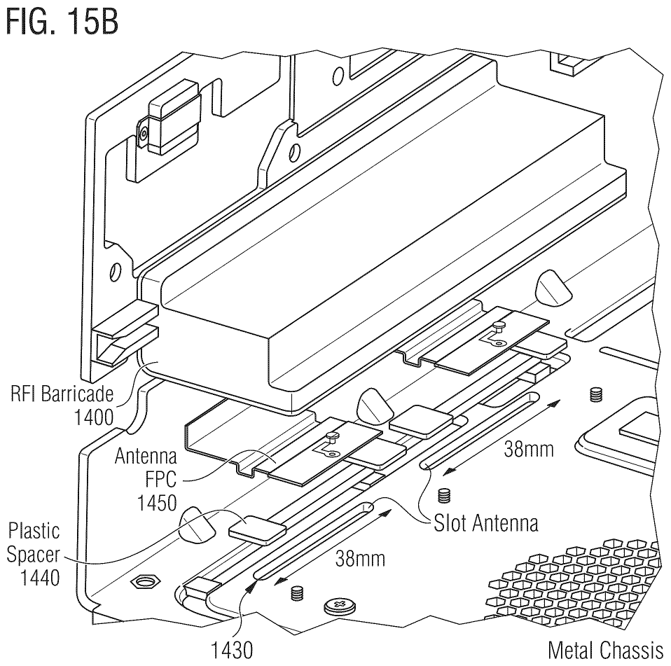

FIG. 15A shows an example barricade 1400 and FIG. 15B shows an integration of slot antennas with the barricade 1400. Two slots 1430 (main and auxiliary), as an example, are formed in the bottom chassis of the device. A plastic spacer 1440 may be inserted in the slots 1430. An antenna FPC 1450 is installed above the slots 1430 and a barricade 1400 is placed over the antennas. The antenna FPC 1450 may be connected to the chassis using a screw which acts as an excitor for the slot.

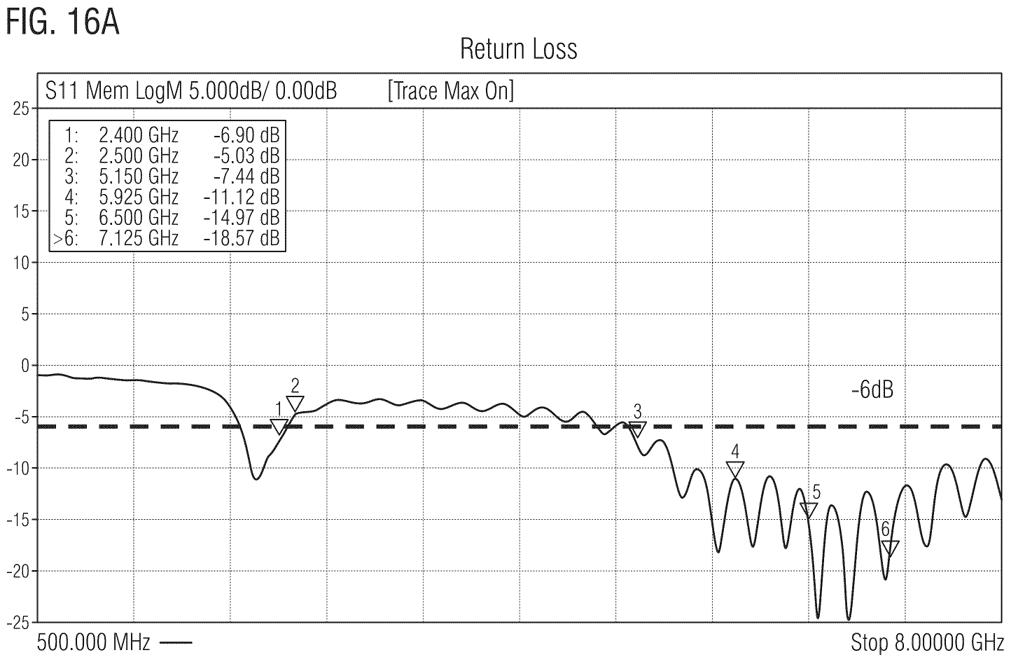

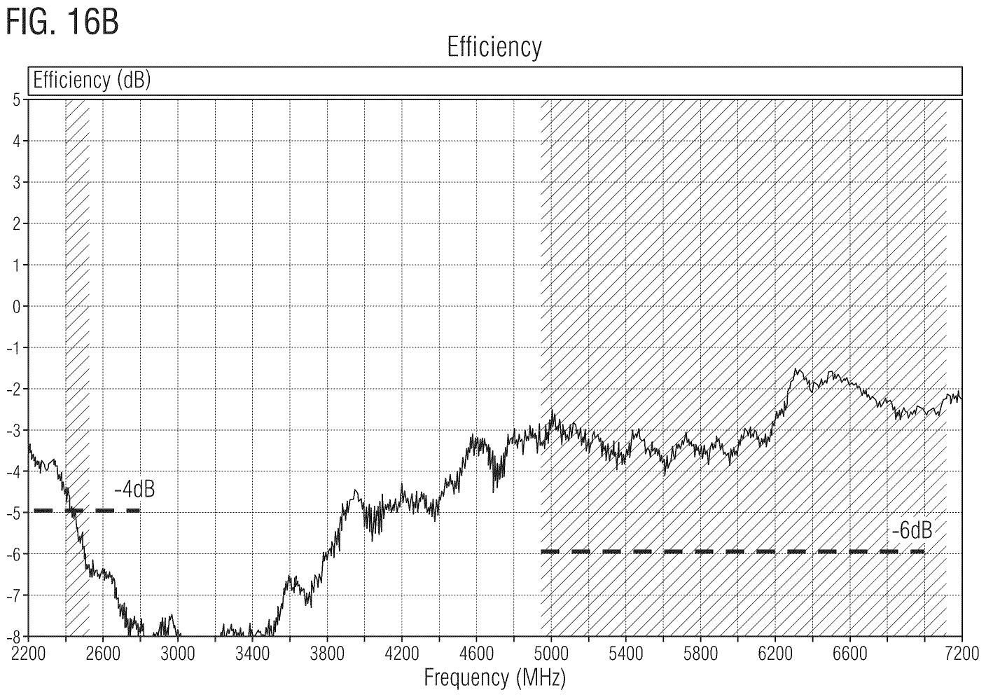

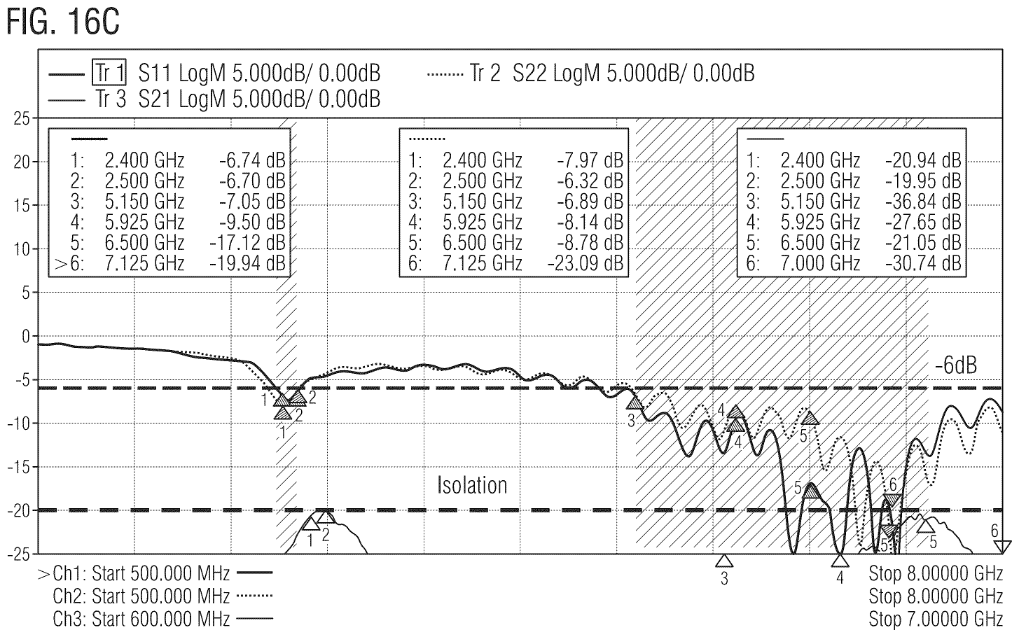

FIGS. 16A, 16B, and 16C show simulation results for return loss, efficiency, and isolation between the antennas, respectively, with the barricade 1400 installed above the slot antenna. FIG. 16A shows −5 dB of return loss for the antenna at 2.4 GHz and −6 dB return loss at 5 GHz band. FIG. 16B shows that the efficiency of the antenna is −5 dB for 2.4 GHz and −4 dB for 5 GHz band. FIG. 16C shows the isolation between the antennas is −20 dB.

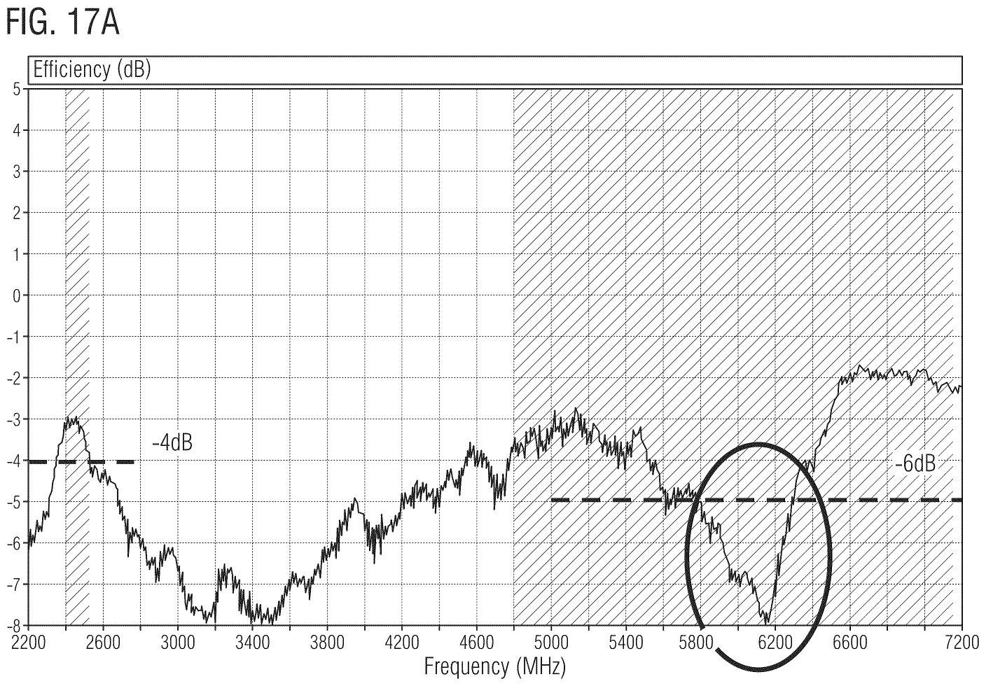

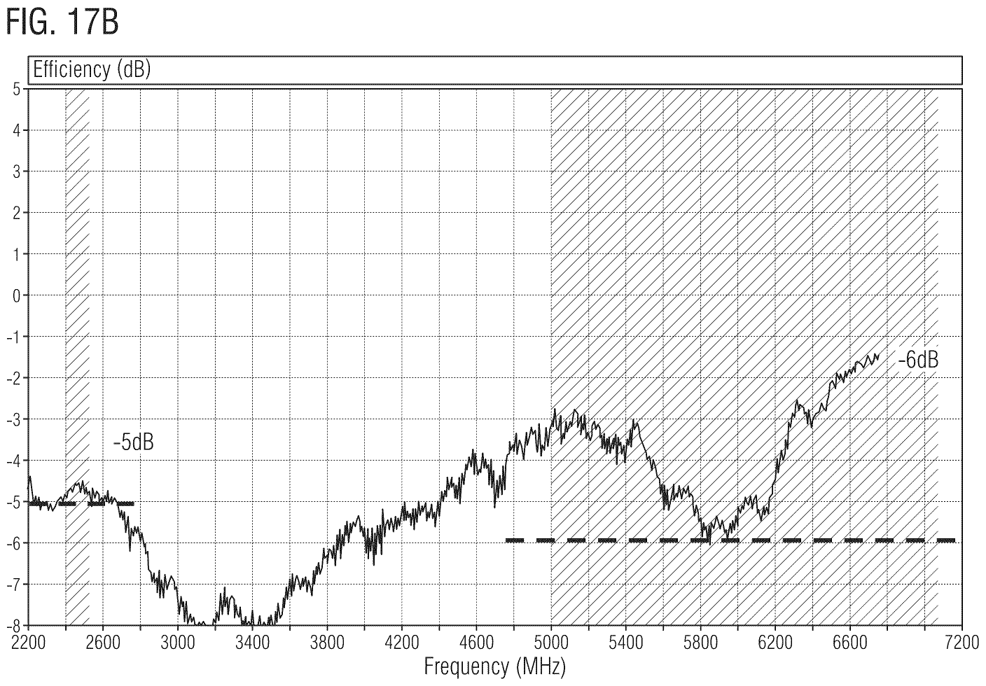

When the barricade is integrated in the system, antenna performance may be degraded because of the presence of metal close to the antenna. Efficiency drops at 6.2 GHz is observed as shown in FIG. 17A. To mitigate the efficiency drop, the internal height of the barricade 1400 may be increased from 8 mm to 10 mm-or set to a certain minimum height in order to minimize the barricade impact on antenna. As the gap between the antenna and the barricade increases, the coupling between the antenna and the metal is reduced which helps to improve the efficiency at 6.2 GHz as shown in FIG. 17B. FIG. 17A shows efficiency drop at 6.2 GHz with a barricade height of 8 mm and FIG. 17B shows improved efficiency at 6.2 GHz band by increasing the internal height of the barricade 1400 to 10 mm.

In another example, a slot antenna may be integrated in a vertical wall of a PC (e.g., a mini desktop PC). As an example, the slot antenna may be used for a metal portal display-less device which works for artificial intelligence (AI) workloads. The placement of the antenna is important as when the AI workloads are running, since it is required to have an antenna seeing the open surroundings for better connectivity with a router. The slot antenna design disclosed herein may solve the antenna integration challenge in the system by placing the antenna on the side wall of the system which provides better performance.

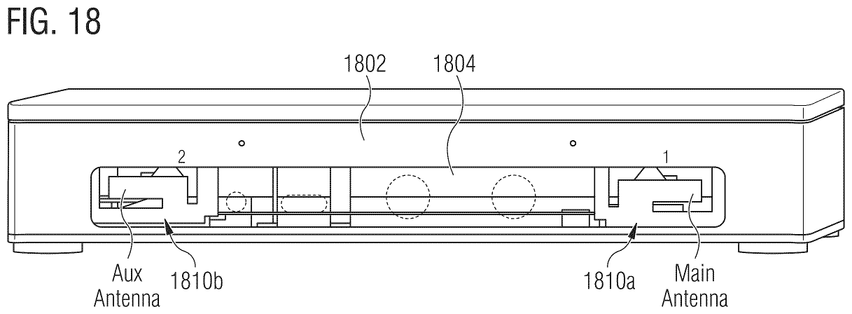

FIG. 18 shows integration of slot antennas on the side wall of a device (e.g., mini desktop PC, etc.). An opening 1804 is formed on the side wall 1802 of the chassis. A half wavelength slot antenna is formed on a PCB 1810a/1810b and the PCB 1810a/1810b is mounted on the side wall 1802 of the chassis. In this example, two slot antennas (main and auxiliary antennas) are mounted on the same wall 1802 of the chassis. Alternatively, one or more than two antennas may be mounted on the same wall or different walls of the chassis.

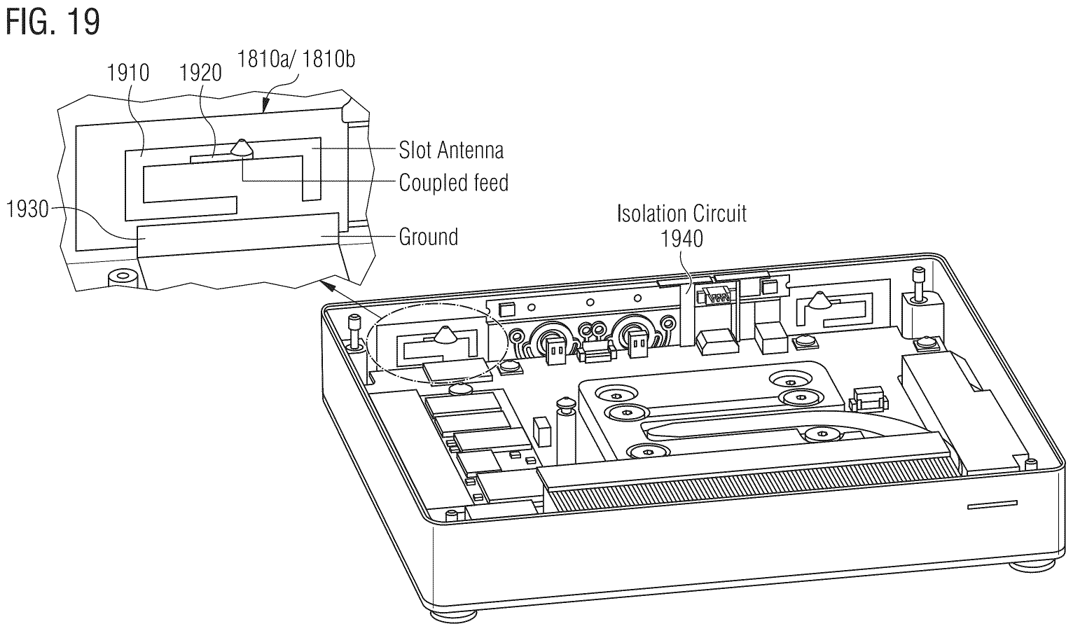

FIG. 19 shows an example slot antenna PCB 1810a/1810b including a slot 1910 formed on the PCB, an exciting element 1920, and a ground plane 1930. A coupled feed method may be used to excite the slot antenna. FIG. 19 shows two slot antennas mounted on the same vertical wall of the chassis with isolation circuit. One antenna PCB 1810a may be mounted on one side of the opening 1804 and the other antenna PCB 1810b may be mounted on the other side of the opening 1804, and an isolation circuit 1940 may be provided in the opening 1804 between the PCBs 1810a and 1810b. An isolation circuit 1940 may be used to improve the isolation between the main antenna 1810a and the auxiliary antennas 1810b. The isolation circuit 1940 connects the top of the opening 1804 to the bottom of the opening 1804 between the two antennas 1810a and 1810b. The isolation circuit provides an alternating path for the current to ground and prevents the currents reaching from one antenna to another antenna. Both the main antenna 1810a and the auxiliary antenna 1810b may be placed on the same plane and the isolation circuit 1940 may be installed between the two antennas 1810a, 1810b.

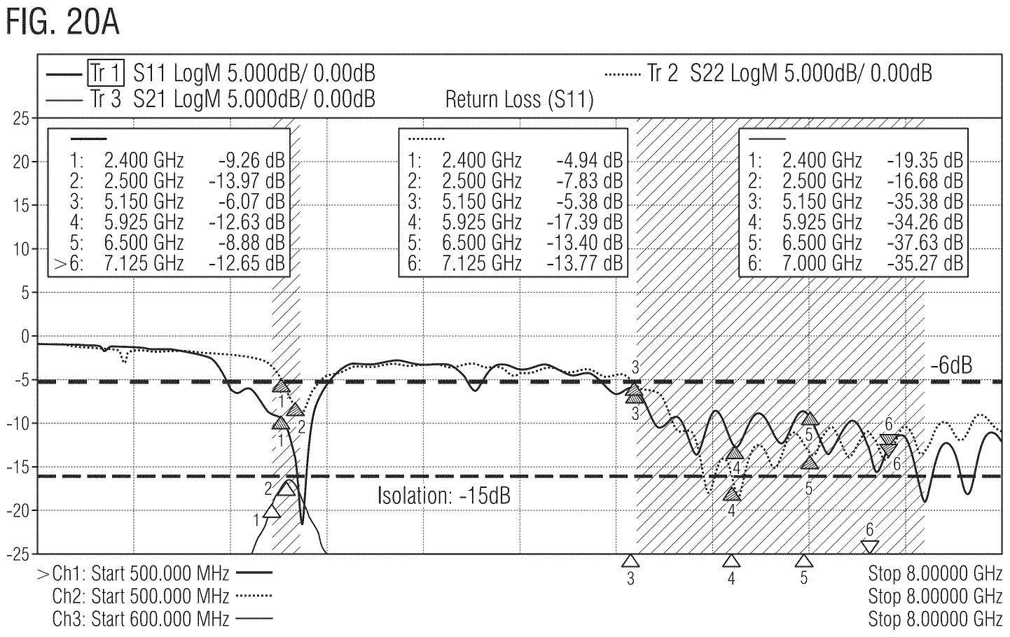

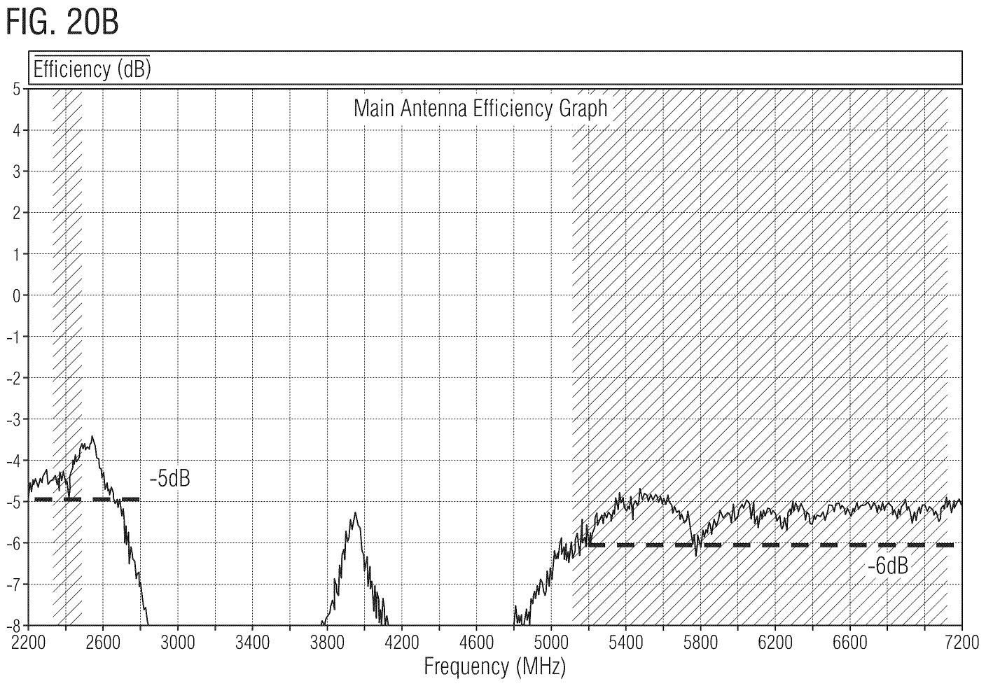

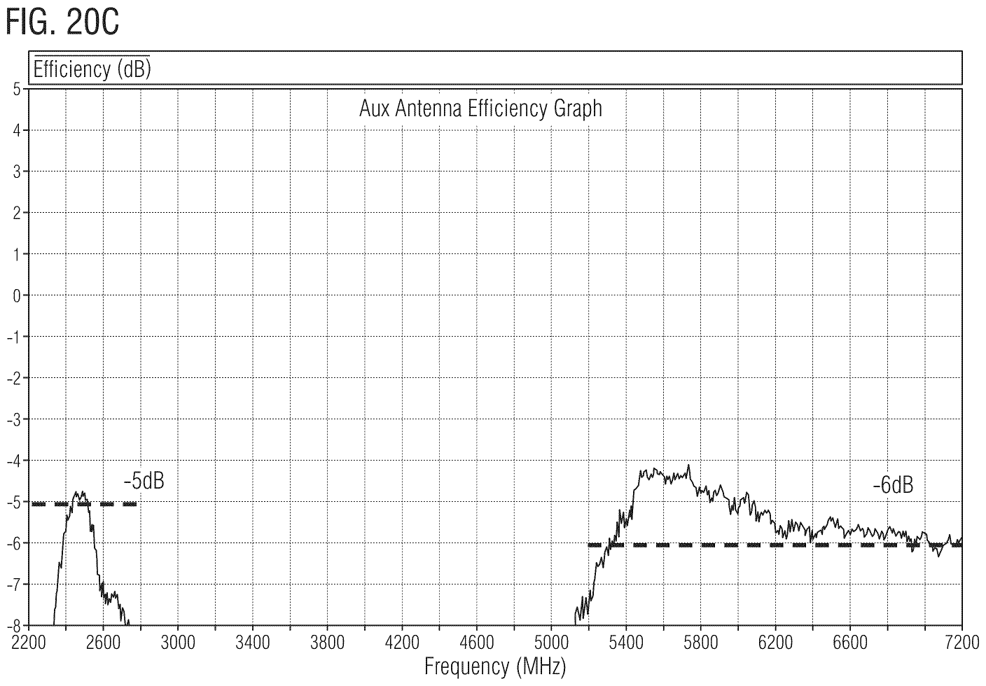

Antenna is tuned to meet the required performance for reflection co-efficient, isolation and efficiency. FIGS. 20A, 20B, and 20C show reflection coefficient (S11), isolation, and efficiency, respectively. As shown in FIGS. 20A-20C, in all the measurements, antenna is meeting the required specification.

In another example, a multi-band resonance antenna is provided in a full metal chassis system with a continual metal rim. Conventional systems require cuts in the metal rim and break the metal edges of the system. Conventional antennas were utilizing the edge of the system as antenna radiating element. To make that radiator, it must be separated from the chassis with cuts in the sidewall. In contrast, in this example, the metal chassis system is provided with a continual metal rim without any cuts or breaks.

Accommodating multiple antennas in a 5G system (or any system requiring multiple antennas) without impacting on other sub-systems (e.g., mechanical strength, design, etc.) is challenging. Meeting the stringent 5G (or similar system) requirements for frequency bands and RF window increases the system design challenges. In general, all antennas are kept in the corner of the system/device (e.g., a mobile device, a laptop, etc.) to achieve good performance.

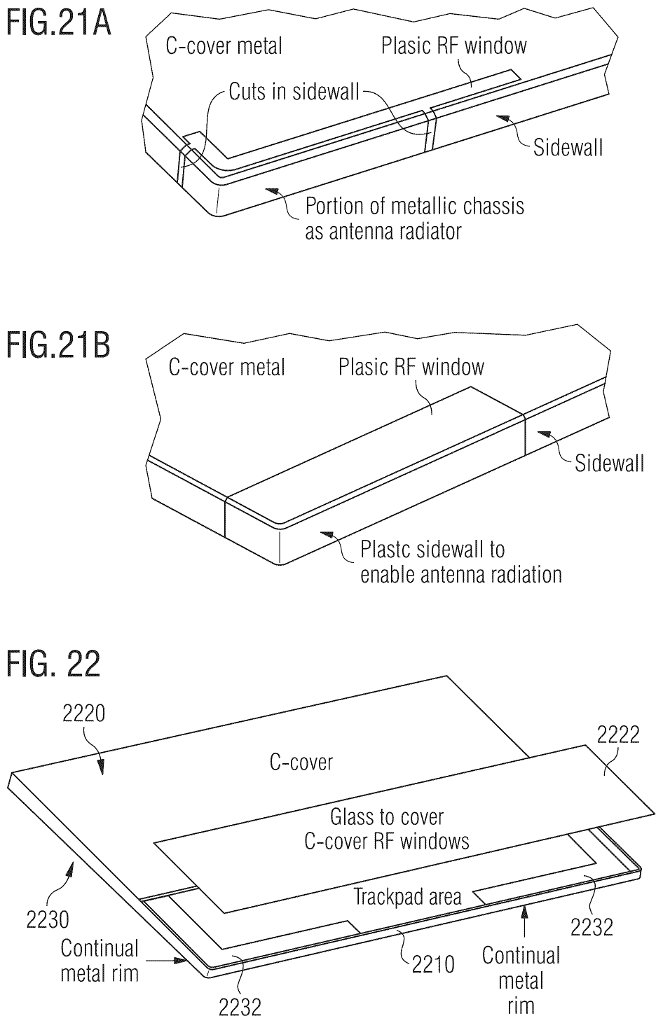

FIGS. 21A and 21B show conventional 5G/Wi-Fi antenna solutions with slots in the sidewall of chassis and full plastic sidewall, respectively. In FIG. 21A, cuts are made in the sidewall of the corner of a device (e.g., a base of a laptop) and the portion of the metallic chassis between the cuts works as an antenna radiator. Specifically for laptops, in case of aperture antenna (the portion of the metal chassis functions as an antenna radiator), the metallic edge becomes a separate part which only has a support from the plastic around it. In FIG. 21B, a plastic sidewall is formed on the corner of a device (e.g., a base of a laptop) to enable antenna radiation.

The plastic RF window or slots in the sidewall make the system mechanically weak. For premium design look, painting should be applied for the plastic window or slots in such systems. Hence, the conventional systems have the limitation of mechanical strength and poor design. A metal edge with cuts is mechanically weak. It requires painting on the chassis for seamless appearance. The portion of chassis used as an antenna radiator may create electrostatic discharge (ESD).

Example multi-band resonance antennas are disclosed herein for avoiding any plastic slots or RF windows in the sidewall of the system (e.g., 5G system). These antennas may be a PCB, a slot type, or any other type where plastic sidewall is needed. It should be noted that the examples will be explained with reference to a laptop computer, but they are applicable to other devices such as a mobile phone, a tablet computer, a desktop computer, etc.

FIG. 22 shows an example metallic chassis with a continual metal rim without any plastic slots in the rim. The metal chassis 2200 includes a continual rim 2210 (a continual side wall of the chassis), a top cover 2220 (e.g., a C-cover of a laptop), and a bottom cover 2230 (e.g., a D-cover of a laptop). The rim 2210 is continual and does not have any cuts or breaks. In this example, an opening 2232 (L shaped opening in this example) is formed in the two front corners of the top cover 2220 and a (plastic) RF window(s) is formed for the antennas in the top cover 2220. Alternatively, the RF windows may be formed in different positions. A glass cover 2222 or any dielectric material may be used to cover the RF windows. With a glass cover 2222, a premium look can be designed without painting. This makes the system mechanically strong with premium industrial design look.

To support 5G connectivity in a system, total four 5G antennas (5G main, 5G diversity, MIMO-03 and MIMO-04 antennas) are required. It should be noted that the example will be explained with reference to the 5G system requiring four (4) antennas, but the examples are applicable to Sixth Generation (6G) and beyond and any system that requires multiple antennas. The frequency band requirements of all the 5G antennas are different and ranging from 617 MHz to 5925 MHz. As 5G frequency band is wide, it is not possible to cover the whole band with stringent requirements such as a continual metal rim of the chassis. In examples, an antenna is provided with a tuner switch (e.g., single-pole single-throw (SPST) or single-pole 4-throw (SP4T) switches) that is used to switch the lower frequency bands of 5G frequency band, i.e., 617-960 MHz, while keeping all other higher frequency bands constant.

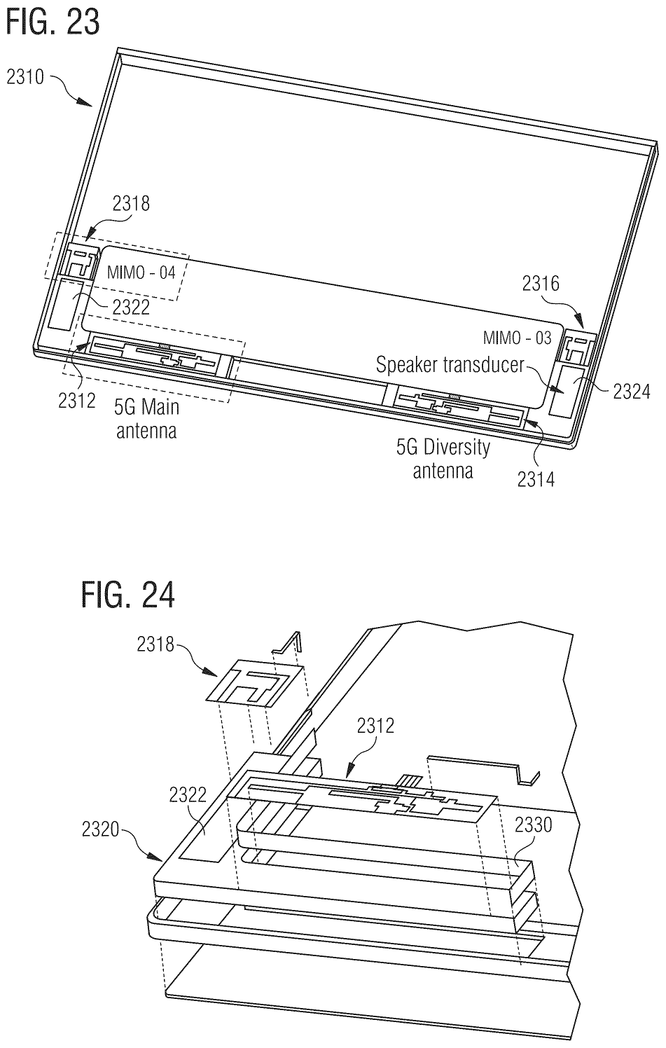

FIG. 23 shows example placement of four 5G antennas (5G main antenna 2312, 5G diversity antenna 2314, first MIMO antenna 2316 and second MIMO antenna 2318) in a continual metal rim chassis 2310 of a laptop. In this example, speaker transducers 2322, 2324 are placed in the front section in both corners of the base of the laptop as shown in FIG. 23, and all antennas 2312, 2314, 2316, 2318 are co-located around the speaker transducers 2322, 2324 in the front section of the base of the laptop. For example, the 5G main antenna 2312 and the second MIMO antenna 2318 may be placed on both sides of the first speaker transducer 2322 and the 5G diversity antenna 2314 and a second MIMO antenna 2316 may be placed on both sides of the second speaker transducer 2324. One or more of the MIMO antennas 2316, 2318 may be replaced by any other antenna (e.g., Wi-Fi antenna).

FIG. 24 shows an extruded view of the 5G main antenna 2312 and the MIMO antenna 2318 placed in a corner of a continual metal rim chassis of a laptop. A speaker box (L-shaped box in this example) 2320 including a speaker transducer 2322 is placed in the corner of the chassis and FPCs for the main antenna 2312 and the MIMO antenna 2318 are placed on both sides of the speaker transducer 2322. A metallic barricade sheet 2330 is mounted on the wall of the speaker box 2320 and the ground of the antenna FPCs of the main antenna 2312 and the MIMO antenna 2318 are connected with the metallic barricade sheet 2330 behind the speaker wall.

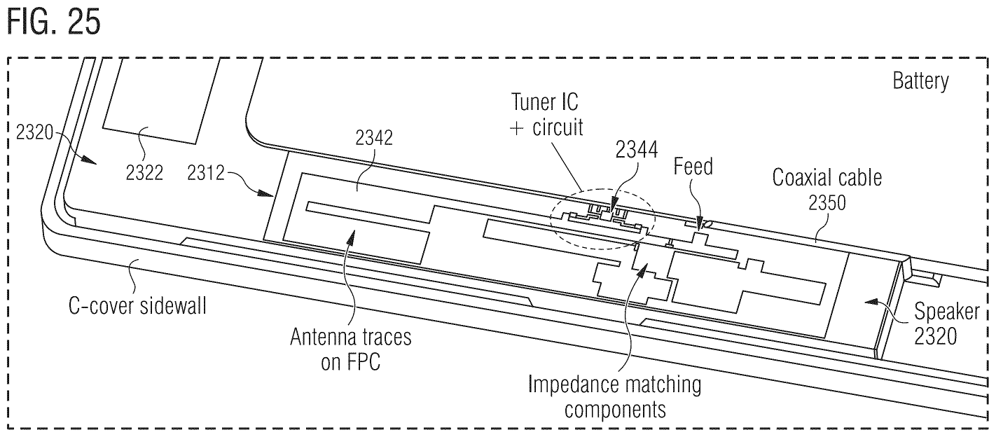

FIG. 25 shows an example 5G main antenna 2312. The 5G main antenna 2312 may be placed in the front section of the base of the laptop near a battery of the laptop. Alternatively, the main antenna 2312 may be placed in different positions. The antenna FPC for the 5G main antenna 2312 may be co-located in the plastic region of the speaker box 2320. The main antenna 2312 may be fed via a coaxial cable 2350.

The 5G main antenna 2312 includes antenna traces for different frequency bands (e.g., antenna trace 2342 for lower frequency band and antenna traces for mid and high frequency bands), tuner circuitry (tuner integrated circuit (IC)) 2344, and impedance matching components on a PCB (e.g., FPC). Different antenna traces are configured for different frequency bands. The 5G main antenna 2312 is provided with a position-based tuner circuitry 2344 (e.g., a tuner IC). With this feature, any plastic cuts (slots) are not needed in the sidewall of the chassis. In examples, the lower frequency band antenna trace 2342 may be taped at two (alternatively one or more than two) different positions and grounded through a switch (the tuner IC 2344) to generate different lower band resonances.

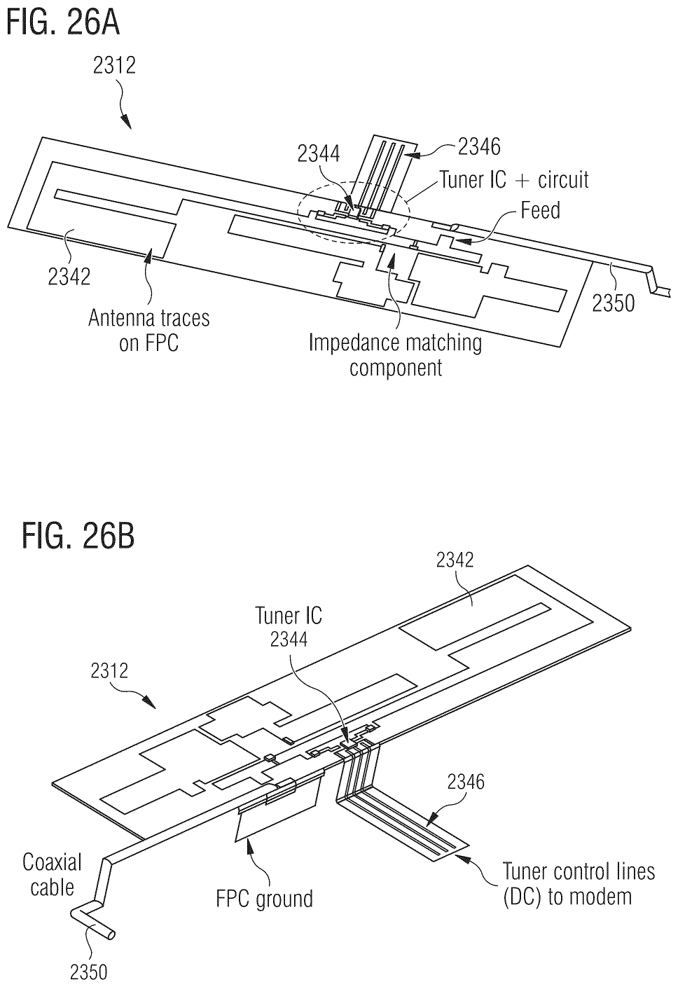

FIG. 26A show the details of the 5G main antenna FPC including a tuner IC 2344 and tuner control lines 2346. FIG. 26B shows the 5G main antenna FPC from a different direction. The antenna FPC may include multiple electric traces (micro strips) configured for different frequency ranges. In examples, the tuner IC 2344 is used to switch only the lower frequency band (the lower frequency band antenna trace 2342), keeping all high frequency bands constant. In this example, three states may be taken to cover the whole 5G bands. However, different number of states may be used to achieve desired performance over frequency bands. For example, it may be implemented using dual SPST antenna aperture shunt switch. Using a tuner switch, 5G frequency bands may be achieved with three different states.

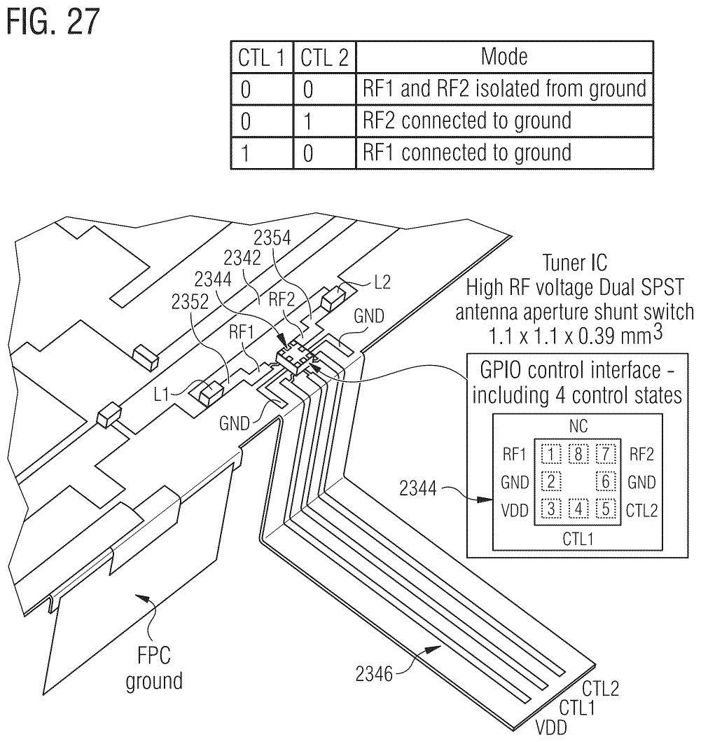

FIG. 27 shows the details of the tuner IC 2344 and tuner control lines 2346. The tuner IC 2344 may tap the lower frequency band antenna trace 2342 to ground at two different positions based on the control signal via the control lines 2346. By tapping the lower frequency band antenna trace 2342 at different positions, the electrical length of the lower frequency band antenna trace 2342 may vary and different lower band resonances may be created. The control signals (CTL1 and CTL2) via the control lines 2346 control the switches in the tuner IC 2344 to selectively tap at no or one of the two positions of the lower frequency band antenna trace 2342 to ground (e.g., FPC ground).

The first state is achieved with the tuner state (CTL1, CTL2)=(0,0) which isolates both the RF1 port 2352 and the RF2 port 2354 of the lower frequency band antenna trace 2342 from the ground. This state can cover the lowest band of 5G frequencies which is 617-798 MHz (5G sub bands: 12, 13, 14, 17, 28, 68, 71, 85) and all other required bands till 5,925 MHz. The second state is achieved with the tuner state (CTL1, CTL2)=(0,1) which connects the RF2 port 2354 of the lower frequency band antenna trace 2342 with the ground. This state covers the frequencies from 791 to 894 MHz (5G sub bands: 5, 18, 19, 20, 26, 27) and all other required bands till 5,925 MHz. The third state is achieved with the tuner state (CTL1, CTL2)=(1,0) which connects the RF1 port 2352 of the lower frequency band antenna trace 2342 with the ground. This state covers the frequencies from 880 to 960 MHz (5G sub band: 8) and all other required bands till 5,925 MHz. With three different tuner states, all the required 5G bands (617-5,925 MHz) are covered.

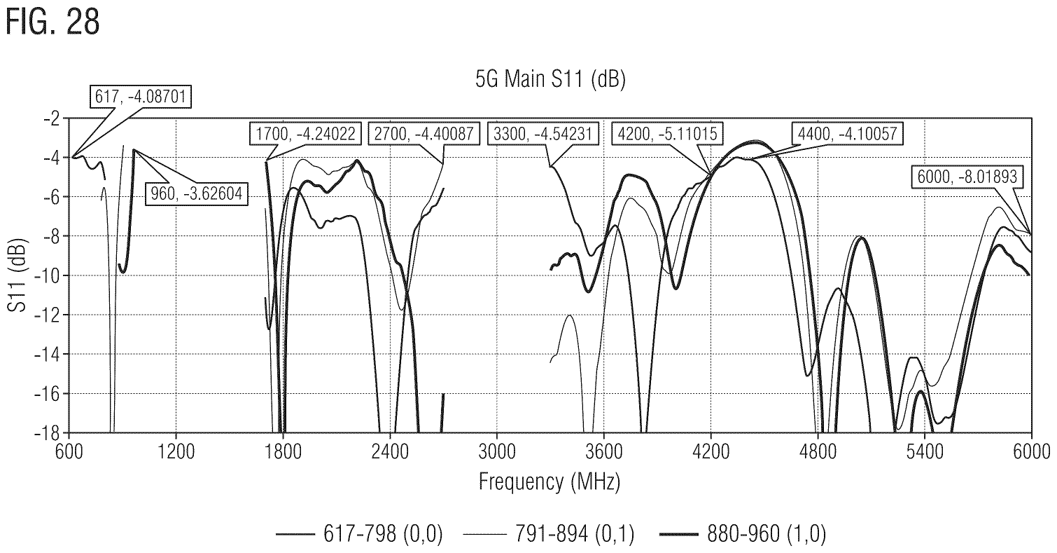

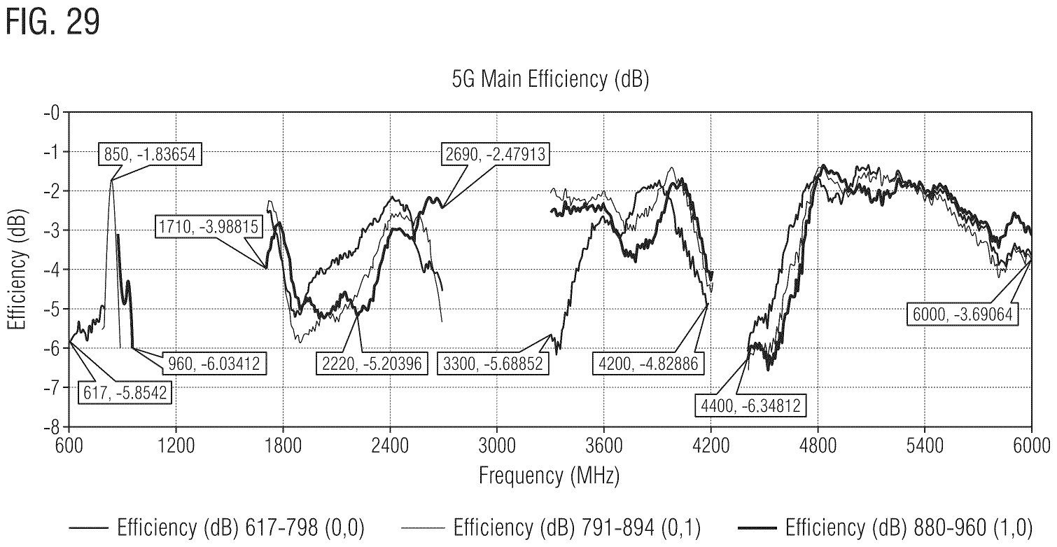

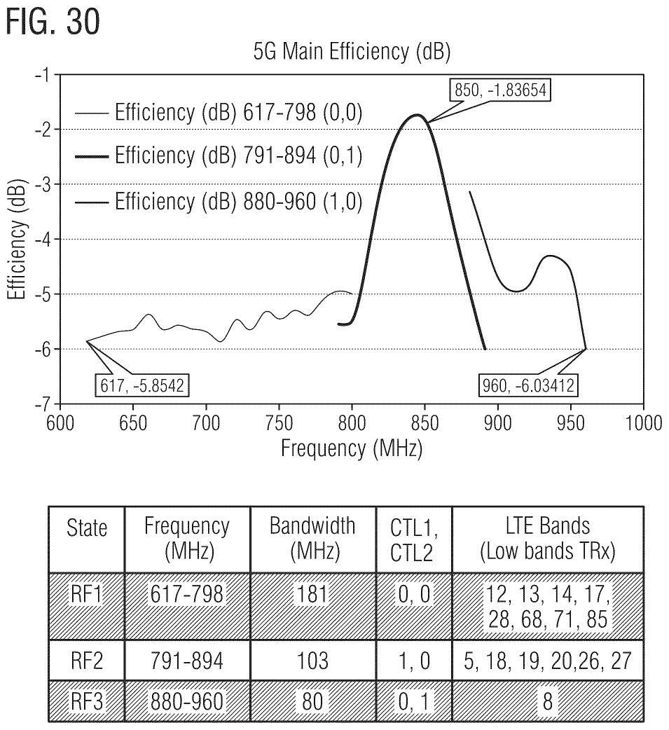

FIGS. 28-30 show the test results (including S11 parameter and efficiency) of the 5G main antenna. FIG. 28 shows S11 parameter (dB) of 5G main antenna for all three tuner states. FIG. 29 shows efficiency (dB) of 5G main antenna for all three tuner states. FIG. 30 shows efficiency (dB) of low band of 5G main antenna for all three tuner states. Table 1 is a table of lower bands of 5G main antenna (617-960 MHz). All the required sub-bands between 617 MHz and 960 MHz are covered in three tuner states: State 1, State 2, and State 3.

TABLE 1

| | Duplex | Uplink | Downlink | | |
|---|---|---|---|---|---|
| Bands | Mode | (MHz) | (MHz) | State | |
| 71 | FDD | 663-698 | 617-652 | RF3 | State-1 |
| 12 | FDD | 699-716 | 729-746 | RF3 | |
| 17 | FDD | 704-716 | 734-746 | RF3 | |
| 85 | FDD | 698-716 | 728-746 | RF3 | |
| 28 | FDD | 703-748 | 758-803 | RF3 | |
| 68 | FDD | 698-728 | 753-783 | RF3 | |
| 13 | FDD | 777-787 | 746-756 | RF3 | |
| 14 | FDD | 788-798 | 758-768 | RF3 | |
| 20 | FDD | 832-862 | 791-821 | RF1 | State-2 |
| 27 | FDD | 807-824 | 852-869 | RF1 | |
| 5 | FDD | 824-849 | 869-894 | RF1 | |
| 18 | FDD | 815-830 | 860-875 | RF1 | |
| 19 | FDD | 830-845 | 875-890 | RF1 | |
| 26 | FDD | 814-849 | 859-894 | RF1 | |
| 8 | FDD | 880-915 | 925-960 | RF2 | State-3 |

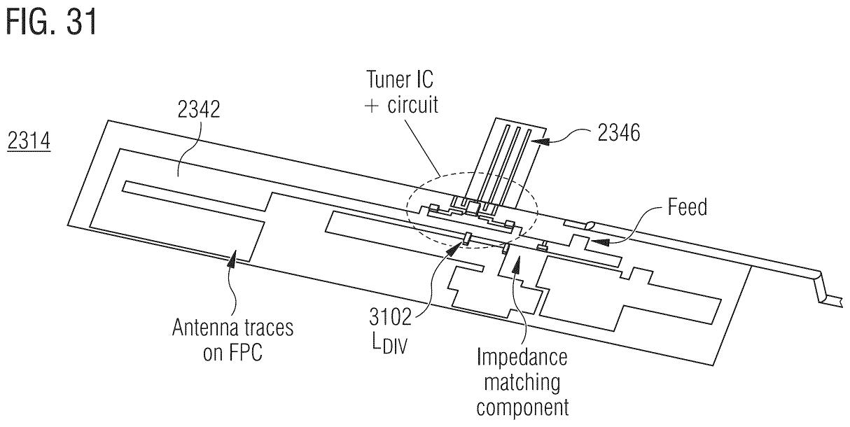

FIG. 31 shows an example 5G diversity antenna FPC. The configuration of the 5G diversity antenna 2314 is similar to the 5G main antenna 2312. The 5G diversity antenna 2314 may be designed with the identical mirrored pattern of the 5G main antenna 2312 except a component (inductor L_{Div} 3102). The Global Positioning System (GPS) band required in the 5G diversity antenna 2314 is covered by placing the inductor L_{Div} 3102 as shown in FIG. 31. The inductor 3102 is used to connect the open trace with the feed line to make the loop structure to achieve the GPS band.

In examples, the tuner IC 2344 may tap the lower frequency band antenna trace 2342 to ground at one (or more) position(s) based on the control signal via the control lines 2346. By tapping the lower frequency band antenna trace 2342, the electrical length of the lower frequency band antenna trace 2342 may vary and different lower band resonances may be created. In examples, as the performance requirements of the diversity antenna 2314 is quite relaxed, all the required sub-bands between 617 MHz and 960 MHz may be covered in two states: state 1 and state 2. This saves the usage of one component from the tuner application.

The first state is achieved with the tuner state (CTL1, CTL2)=(0,0) which isolates both the RF1 port 2352 and the RF2 port 2354 of the lower frequency band antenna trace 2342 from the ground. The second state is achieved with the tuner state (CTL1, CTL2)=(0,1) which connects the RF2 port 2354 of the lower frequency band antenna trace 2342 with the ground.

Table 2 shows the frequency sub-bands of the 5G diversity antenna (617-960 MHz) covered by the first and second states.

TABLE 2

| | Duplex | Uplink | Downlink | | |
|---|---|---|---|---|---|
| Bands | Mode | (MHz) | (MHz) | State | |
| 71 | FDD | 663-698 | 617-652 | RF1 | State-1 |
| 12 | FDD | 699-716 | 729-746 | RF1 | |
| 17 | FDD | 704-716 | 734-746 | RF1 | |
| 85 | FDD | 698-716 | 728-746 | RF1 | |
| 28 | FDD | 703-748 | 758-803 | RF1 | |
| 68 | FDD | 698-728 | 753-783 | RF1 | |
| 13 | FDD | 777-787 | 746-756 | RF1 | |
| 14 | FDD | 788-798 | 758-768 | RF1 | |
| 20 | FDD | 832-862 | 791-821 | RF1 | |
| 27 | FDD | 807-824 | 852-869 | RF1 | |
| 5 | FDD | 824-849 | 869-894 | RF1 | |
| 18 | FDD | 815-830 | 860-875 | RF1 | |
| 19 | FDD | 830-845 | 875-890 | RF1 | |
| 26 | FDD | 814-849 | 859-894 | RF1 | |
| 8 | FDD | 880-915 | 925-960 | RF2 | State-2 |

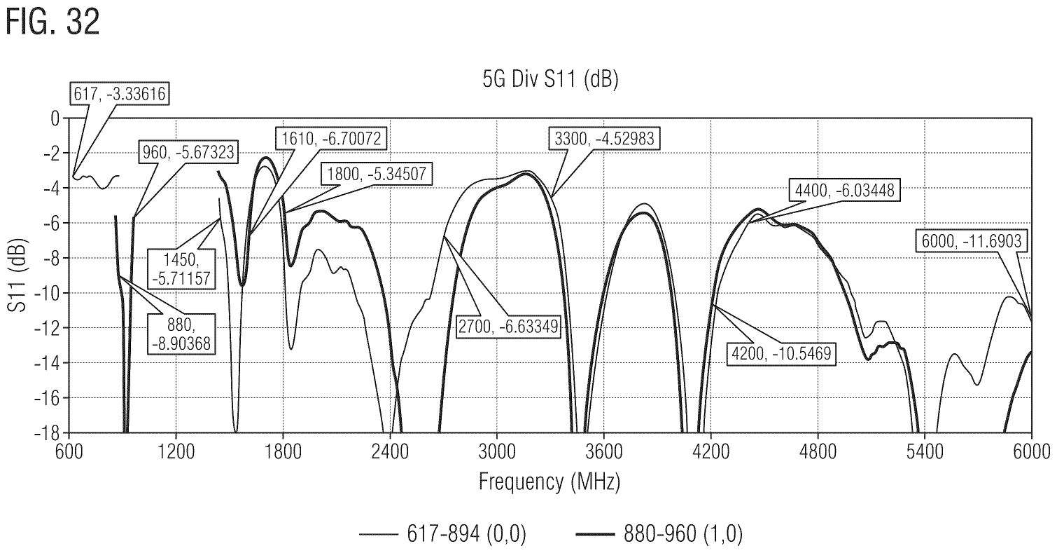

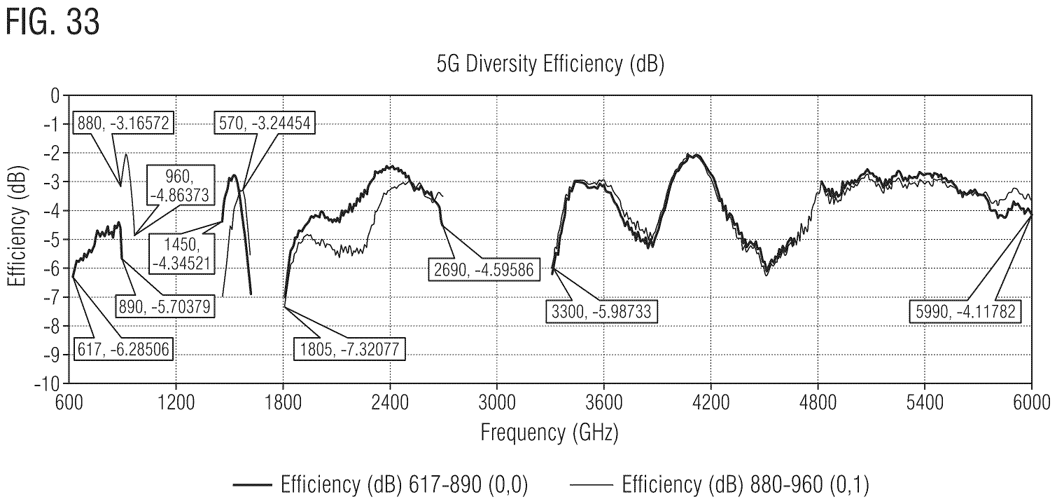

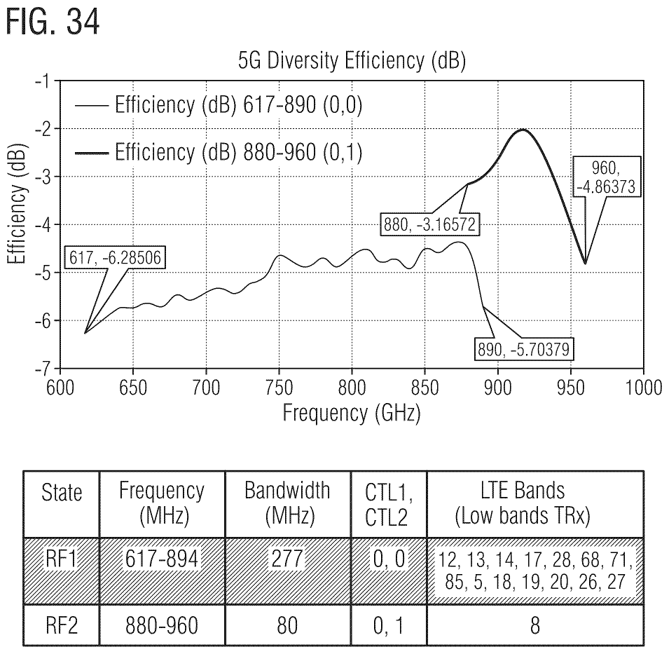

FIGS. 32-34 shows the test results (including S11 and efficiency) of the 5G diversity antenna. FIG. 32 shows S11 parameters (dB) of the 5G diversity antenna for all two tuner states. FIG. 33 shows efficiency (dB) of the 5G diversity antenna for all two tuner states. FIG. 34 shows efficiency (dB) of the low band of the 5G diversity antenna for all two tuner states.

In the slot (L-shaped slot in the example) surrounded with the metal rim, a MIMO antenna 2316/2318 is placed close to the 5G main/diversity antenna 2312/2314. In some examples, there may be no separate slot for the MIMO antenna. As shown in FIGS. 22-24, there may be only one L-shaped slot within which the 5G main and MIMO antennas are placed. In examples, the MIMO antenna 2316/2318 is placed around the speaker transducer. The speaker transducer separates the MIMO antenna and the main/diversity antenna to achieve required isolation and may work as an isolator.

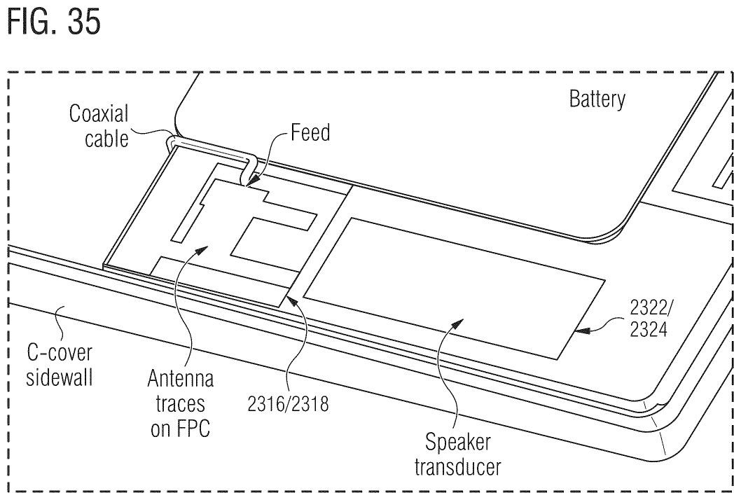

FIG. 35 shows an example MIMO antenna FPC in a system. In examples, the MIMO antenna 2316/2318 may be designed such that the grounding of the antenna trace (to make inverted-F antenna structure) may be on the opposite side of the 5G main/diversity antenna to achieve good isolation. The speaker transducer 2322/2324 may be in between the 5G main/diversity antenna 2312/2314 and the MIMO antenna 2316/2318 for better isolation.

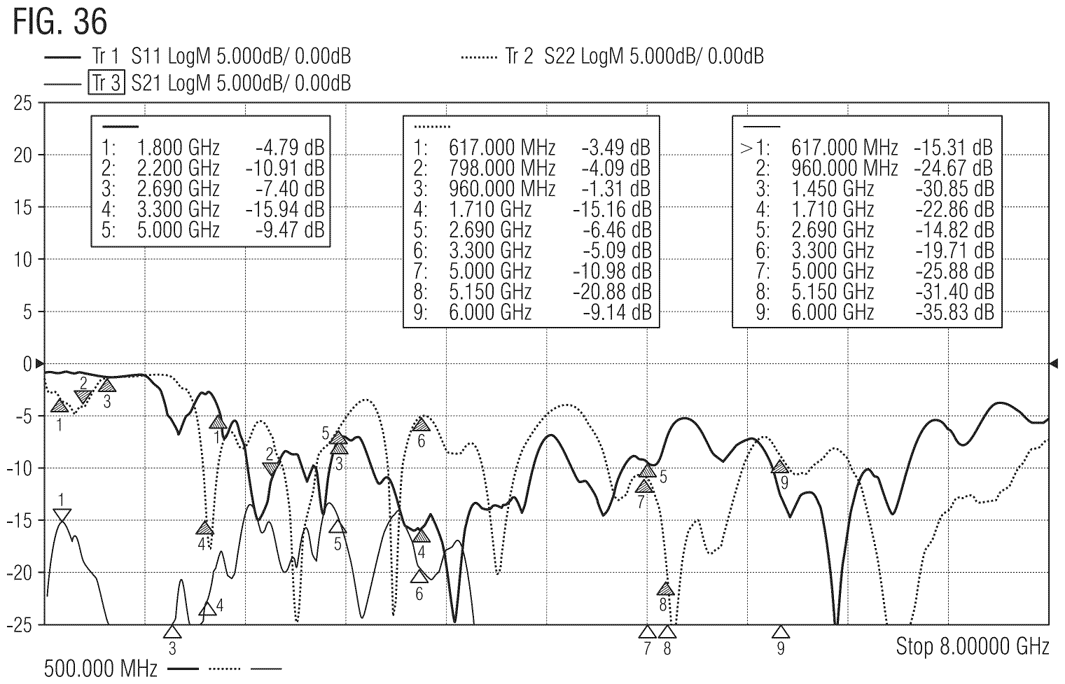

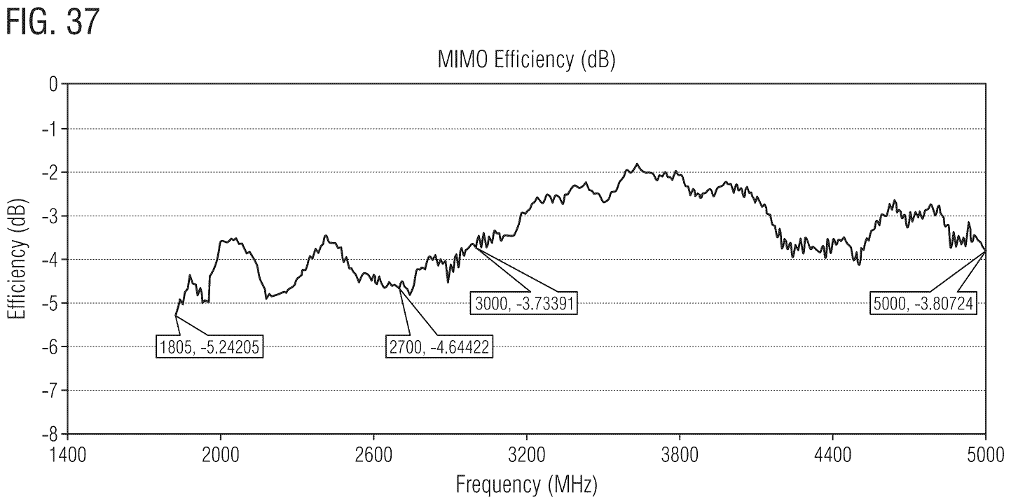

FIGS. 36 and 37 show the test results including S11, isolation (S12) and efficiency. FIG. 36 shows 5G Main (S11), S12 (isolation), MIMO (S22) dB. FIG. 37 shows efficiency (dB) of the MIMO antenna.

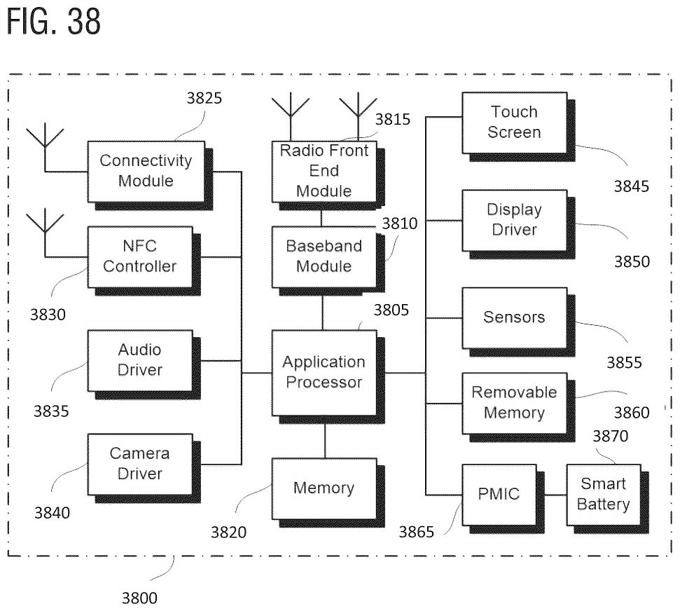

FIG. 38 illustrates a user device 3800 in which the examples disclosed herein may be implemented. For example, the examples disclosed herein may be implemented in the radio front-end module 3815, in the baseband module 3810, etc. The user device 3800 may be a mobile device in some aspects and includes an application processor 3805, baseband processor 3810 (also referred to as a baseband module), radio front end module (RFEM) 3815, memory 3820, connectivity module 3825, near field communication (NFC) controller 3830, audio driver 3835, camera driver 3840, touch screen 3845, display driver 3850, sensors 3855, removable memory 3860, power management integrated circuit (PMIC) 3865 and smart battery 3870.

In some aspects, application processor 3805 may include, for example, one or more CPU cores and one or more of cache memory, low drop-out voltage regulators (LDOs), interrupt controllers, serial interfaces such as serial peripheral interface (SPI), inter-integrated circuit (I2C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 3810 may be implemented, for example, as a solder-down substrate including one or more integrated circuits, a single packaged integrated circuit soldered to a main circuit board, and/or a multi-chip module containing two or more integrated circuits.

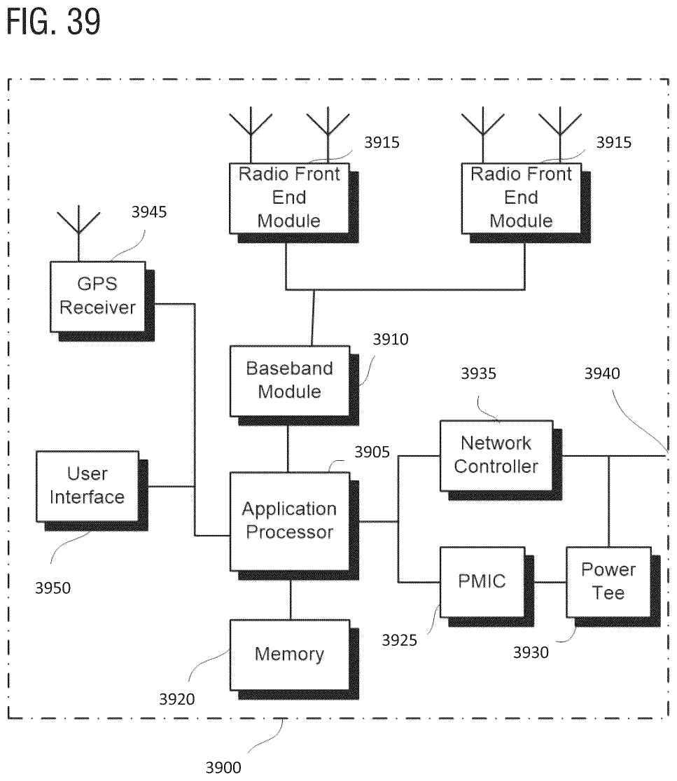

FIG. 39 illustrates a base station or infrastructure equipment radio head 3900 in which the examples disclosed herein may be implemented. For example, the examples disclosed herein may be implemented in the radio front-end module 3915, in the baseband module 3910, etc. The base station radio head 3900 may include one or more of application processor 3905, baseband modules 3910, one or more radio front end modules 3915, memory 3920, power management circuitry 3925, power tee circuitry 3930, network controller 3935, network interface connector 3940, satellite navigation receiver module 3945, and user interface 3950.

In some aspects, application processor 3905 may include one or more CPU cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 3910 may be implemented, for example, as a solder-down substrate including one or more integrated circuits, a single packaged integrated circuit soldered to a main circuit board or a multi-chip module containing two or more integrated circuits.

In some aspects, memory 3920 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto resistive random access memory (MRAM) and/or a three-dimensional crosspoint memory. Memory 3920 may be implemented as one or more of solder down packaged integrated circuits, socketed memory modules and plug-in memory cards.

In some aspects, power management integrated circuitry 3925 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 3930 may provide for electrical power drawn from a network cable to provide both power supply and data connectivity to the base station radio head 3900 using a single cable.

In some aspects, network controller 3935 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 3945 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 3945 may provide data to application processor 3905 which may include one or more of position data or time data. Application processor 3905 may use time data to synchronize operations with other radio base stations.

In some aspects, user interface 3950 may include one or more of physical or virtual buttons, such as a reset button, one or more indicators such as light emitting diodes (LEDs) and a display screen.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a multi-band resonance slot antenna comprising a slot formed in a conductive plate, wherein a length of the slot is less than a half wavelength of a desired resonance frequency, an exciting trace configured to excite the slot, and a tuning stub within an area of the slot, wherein the tuning stub is an electric trace in an elongated shape along the slot and connected to a ground plane of the slot antenna.

Another example, (e.g., example 2) relates to a previously described example (e.g., example 1), wherein the tuning stub is connected to the ground plane via a capacitor or an inductor.

Another example, (e.g., example 3) relates to a previously described example (e.g., any one of examples 1-2), wherein the exciting trace is in a planar inverted-F antenna (PIFA) configuration.

Another example, (e.g., example 4) relates to a previously described example (e.g., any one of examples 1-3), wherein the tuning stub is configured to generate resonance of the slot antenna in a range of 2.4-2.5 GHz and 5.15-7.125 GHz.

Another example, (e.g., example 5) relates to a previously described example (e.g., example 4), wherein the tuning stub is configured to generate one resonance in a range of 2.4-2.5 GHz and two resonances in a range of 5.15-7.125 GHz.

Another example, (e.g., example 6) relates to a multi-band resonance antenna comprising an electric trace on a printed circuit board, a control line configured to transfer a control signal, and a tuner circuit configured to tap at one or more points of the electric trace to ground based on the control signal.

Another example, (e.g., example 7) relates to a previously described example (e.g., example 6), wherein the electric trace is configured to generate resonance at 617-798 MHz when no point of the electric trace is tapped to ground, at 791-894 MHz when the electric trace is tapped to ground at a first point, and at 880-960 MHz when the electric trace is tapped to ground at a second point.

Another example, (e.g., example 8) relates to a previously described example (e.g., any one of examples 6-7), wherein the electric trace is configured to generate resonance at 617-894 MHz when no point of the electric trace is tapped to ground, and at 880-960 MHz when the electric trace is tapped to ground at a first point.

Another example, (e.g., example 9) relates to a device comprising a chassis including a continual metal rim, a top cover, and a bottom cover, and one or more antennas including the multi-band resonance antenna as in any one of examples 1-8.

Another example, (e.g., example 10) relates to a previously described example (e.g., example 9), wherein the one or more antennas includes a main antenna, a diversity antenna, third and fourth antennas, wherein the main antenna and the diversity antenna are the multi-band resonance antenna as in any one of examples 1-8.

Another example, (e.g., example 11) relates to a previously described example (e.g., any one of examples 9-10), further including a first speaker transducer and a second speaker transducer, wherein the first speaker transducer is placed between the main antenna and the third antenna, and the second speaker transducer is placed between the diversity antenna and the fourth antenna.

Another example, (e.g., example 12) relates to a previously described example (e.g., any one of examples 9-11), wherein the third and fourth antennas are multiple-input multiple- output (MIMO) antennas.

Another example, (e.g., example 13) relates to a previously described example (e.g., any one of examples 9-11), wherein the third antenna is a Wi-Fi antenna.

Another example, (e.g., example 14) relates to a previously described example (e.g., any one of examples 9-13), wherein the top cover includes an opening, and the device includes a glass cover to cover the opening.

Another example, (e.g., example 15) relates to a device comprising a chassis including a bottom metal plate, the bottom metal plate including a slot, a printed circuit board (PCB) including an electric trace configured to excite the slot, wherein the PCB is mounted on the bottom metal plate, and a metal barricade mounted over the slot and the PCB, wherein the metal barricade includes metal side walls and a metal top to cover the slot and the PCB.

Another example, (e.g., example 16) relates to a previously described example (e.g., example 15), wherein the bottom metal plate includes multiple slots, and the metal barricade includes one or more metal partitions for separating each of the multiple slots.

Another example, (e.g., example 17) relates to a previously described example (e.g., any one of examples 15-16), wherein the metal barricade has an internal height of at least 15mm.

Another example, (e.g., example 18) relates to a device comprising a chassis including a metal side wall, the metal side wall including an opening, and a slot antenna mounted on the metal side wall behind the opening.

Another example, (e.g., example 19) relates to a previously described example (e.g., example 18), wherein the slot antenna includes a main slot antenna and an auxiliary slot antenna mounted on the metal side wall behind the opening, wherein the chassis includes an isolation circuit placed between the main slot antenna and the auxiliary slot antenna and configured to connect a top of the opening and a bottom of the opening.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . .” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts,-functions,-processes,-operations or-steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that-although a dependent claim may refer in the claims to a specific combination with one or more other claims-other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A multi-band resonance slot antenna comprising:
a slot formed in a conductive plate, wherein a length of the slot is less than a half wavelength of a desired resonance frequency;
an exciting trace configured to excite the slot; and
a tuning stub within an area of the slot, wherein the tuning stub is an electric trace in an elongated shape along the slot and connected to a ground plane of the slot antenna.

2. The multi-band resonance slot antenna of claim 1, wherein the tuning stub is connected to the ground plane via a capacitor or an inductor.

3. The multi-band resonance slot antenna of claim 1, wherein the exciting trace is in a planar inverted-F antenna (PIFA) configuration.

4. The multi-band resonance slot antenna of claim 1, wherein the tuning stub is configured to generate resonance of the slot antenna in a range of 2.4-2.5 GHz and 5.15-7.125 GHz.

5. The multi-band resonance slot antenna of claim 4, wherein the tuning stub is configured to generate one resonance in a range of 2.4-2.5 GHz and two resonances in a range of 5.15-7.125 GHz.

6. A multi-band resonance antenna comprising:
an electric trace on a printed circuit board;
a control line configured to transfer a control signal; and
a tuner circuit configured to tap at one or more points of the electric trace to ground based on the control signal.

7. The multi-band resonance antenna of claim 6, wherein the electric trace is configured to generate resonance at 617-798 MHz when no point of the electric trace is tapped to ground, at 791-894 MHz when the electric trace is tapped to ground at a first point, and at 880-960 MHz when the electric trace is tapped to ground at a second point.

8. The multi-band resonance antenna of claim 6, wherein the electric trace is configured to generate resonance at 617-894 MHz when no point of the electric trace is tapped to ground, and at 880-960 MHz when the electric trace is tapped to ground at a first point.

9. A device comprising:
a chassis including a continual metal rim, a top cover, and a bottom cover;
one or more antennas including the multi-band resonance antenna of claim 6.

10. The device of claim 9, wherein the one or more antennas includes a main antenna, a diversity antenna, third and fourth antennas, wherein the main antenna and the diversity antenna are the multi-band resonance antenna.

11. The device of claim 10, further including a first speaker transducer and a second speaker transducer, wherein the first speaker transducer is placed between the main antenna and the third antenna, and the second speaker transducer is placed between the diversity antenna and the fourth antenna.

12. The device of claim 10, wherein the third and fourth antennas are multiple-input multiple-output (MIMO) antennas.

13. The device of claim 10, wherein the third antenna is a Wi-Fi antenna.

14. The device of claim 9, wherein the top cover includes an opening, and the device includes a glass cover to cover the opening.

15. A device comprising:
a chassis including a bottom metal plate, the bottom metal plate including a slot;
a printed circuit board (PCB) including an electric trace configured to excite the slot, wherein the PCB is mounted on the bottom metal plate; and
a metal barricade mounted over the slot and the PCB, wherein the metal barricade includes metal side walls and a metal top to cover the slot and the PCB.

16. The device of claim 15, wherein the bottom metal plate includes multiple slots, and the metal barricade includes one or more metal partitions for separating each of the multiple slots.

17. The device of claim 15, wherein the metal barricade has an internal height of at least 15 mm.
